(19) United States
(12) Patent Application Publication
(10) Pub. No.: US 2010/0228653 A1
(43) Pub. Date: Sep. 9, 2010

(54) DATA REPRODUCTION DEVICE, CONTENT DELIVERY SYSTEM, AND CONTENT DELIVERY METHOD

(75) Inventors: Kei YAMAJI, Kanagawa (JP); Yuko SUZUKI, Kanagawa (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/718,680

(22) Filed: Mar. 5, 2010

(30) Foreign Application Priority Data
Mar. 5, 2009 (JP) 2009-052097
Feb. 5, 2010 (JP) 2010-024233

(51) Int. Cl. G06F 3/048; G06F 15/16; G06Q 30/00; G06Q 10/00

(52) U.S. Cl. 705/34; 715/810; 709/217

(57) ABSTRACT

A content delivery system includes a data reproduction device and an in-store terminal that are connected to each other via a communication line. The data reproduction device includes a reproduction device for reproducing contents, a content element selection device, a transmission device for transmitting content element selection information and a reception device for receiving the contents, while the in-store terminal includes a data input device for inputting content information, a content element generation device, a reception device for receiving the content element selection information, a content generation modification device, a storage device, and a transmission device for transmitting contents. The in-store terminal generates contents based on content elements selected by the user of the data reproduction device, and the data reproduction device reproduces the contents received from the in-store terminal.

### BACKGROUND OF THE INVENTION

The present invention relates to a data reproduction device, a content delivery system and a content delivery method in which a digital photo frame (a data reproduction device; hereinafter referred to also as “DPF” or an electronic picture frame) and an in-store terminal work together to easily obtain and modify contents to be reproduced by the DPF.

Conventionally, an electronic picture frame has been used to display still images, and apparatuses in which a data handling device or a data management device controls the display of the electronic picture frame which is connected to a network or modifies the images on the DPF have been suggested.

According to JP 2007-199190 A, a particular image among all images displayed on a display panel like an electronic picture frame is selected by a user to be displayed by a display device having a large size screen, enabling the image desired by the user to be viewed by a large number of viewers. In addition, the display panel can selectively display an image specifically interesting for a particular person so that it may draw his or her attention to the displayed image.

JP 2005-331884 A discloses an image display system for displaying an image on a wall or the like located at a site passed by a large number of passersby, while the system detects the number of passersby and the direction they are heading and displays an image in accordance with the detection results.

JP 2005-242758 A discloses a news article delivery system which surely delivers a user an article relating to a past article previously delivered to the user.

However, the apparatus described in JP 2007-199190 A preliminarily stores images, and from which the apparatus selects an image to be displayed on the large size screen; the apparatus fails to satisfy a user's desire, for example, to compose a frame image onto the image displayed on the screen, as it requires to have a composed image prepared prior to displaying it on the screen.

The image display system described in JP 2005-331884 A obtains information on a space in which an image is to be displayed and displays an image that is suitable for the obtained information. The image to be displayed in the system is preliminarily generated, and a new image cannot be generated in accordance with the information on the space where the image is to be displayed.

In the system of JP 2005-242758 A, a related article to be delivered to each user is selected based on the information on the article delivery history of the user, but the system cannot selectively deliver an article suitable for a location of the user.

While contents have been commonly delivered from a server to a reproduction terminal, the terminal may vary in its usage situation as shown in Table 1, depending on the type of the terminal.

TABLE 1

| Reproduction | | | | |
|---|---|---|---|---|
| Terminal | Used by | Portability | Functions | Operability |
| Mobile phone | One person | Excellent | Many | Bad |
| Desktop PC | One person | Bad | Many | Bad |
| Laptop PC | One person | Fair | Many | Bad |
| Television | One or more | Bad | Few | Fair (with a |
| | persons | | | remote control) |
| DPF | One or more | Good | Few | Good (intuitively |
| | persons | | | operable with a |
| | | | | touch screen) |

Note that a reproduction terminal such as a DPF that is used by one or more persons (viewers) and highly portable as shown in Table 1 may be more frequently exposed to different environments when reproducing contents than other types of reproduction terminals. Hence, contents needed to be delivered in a suitable condition depending on the number of users and the location (environment) that may vary to reproduce the contents.

### SUMMARY OF THE INVENTION

It is therefore an object of the present invention to solve the above-described problems and provide a content delivery system as well as a content delivery method in which a most suitable set of contents can be generated and delivered in accordance with a user's preference or a location of a user. It is another object of the present invention to provide a data reproduction device used in such a content delivery system for reproducing image data or other data.

In order to solve the above-described problems, the present invention provides a data reproduction device comprising: reproduction means for displaying a list of content elements that is generated based on data obtained from content information on at least one of a still image, a motion picture, text and music and reproducing contents that are generated and modified based on content elements selected from the list of content elements; content element selection means for selecting content elements from the list of content elements displayed by the reproduction means and generating content element selection information on the selected content elements; first transmission means for transmitting the content element selection information generated by the content element selection means to an in-store terminal; first reception means for receiving from the in-store terminal the list of content elements and the contents to be reproduced; and first storage means for storing the list of content elements and the contents received by the first reception means.

The present invention also provides a content delivery system in which the above-described data reproduction device and an in-store terminal are connected with each other via a communication line,

wherein the in-store terminal comprises: data input means for inputting the content information on at least one of a still image, a motion picture, text and music as the data; content element generation means for processing the data input by the data input means to generate the content elements and the list of the content elements; second reception means for receiving the content element selection information from the data reproduction device; content generation/modification means for generating and modifying the contents based on the content elements by using the content element selection information; second storage means for storing the input data, the generated content elements, the generated and modified contents, and user information; and second transmission means for transmitting the list of content elements and the generated and modified contents to the data reproduction device, and

wherein the in-store terminal generates the contents based on the content elements selected by the data reproduction device, and the data reproduction device reproduces the contents received from the in-store terminal.

The present invention further provides a method for delivering contents for which a data reproduction device and an in-store terminal communicate with each other, comprising steps of: inputting data of at least one of a still image, a movie, text and music into the in-store terminal; processing the data to generate content elements and a list of content elements in the in-store terminal; transmitting the list of content elements from the in-store terminal to the data reproduction device; receiving the list of content elements transmitted from the in-store terminal by the data reproduction device; displaying the list of content elements by reproduction means in the data reproduction device; selecting content elements from the list of content elements by a user, the content elements being displayed by the reproduction means, and generating content element selection information by the data reproduction device; transmitting the content element selection information from the data reproduction device to the in-store terminal; receiving the content element selection information transmitted from the data reproduction device by the in-store terminal; generating and modifying contents based on the content element selection information and the content elements by the in-store terminal; transmitting the generated contents from the in-store terminal to the data reproduction device; receiving the contents transmitted from the in-store terminal by the data reproduction device; and reproducing the received contents by the data reproduction device.

### BRIEF DESCRIPTION OF THE DRAWINGS

FIG. 1 is a diagram schematically showing the system configuration of a content delivery system according to a first embodiment of the present invention.

FIG. 2 is a block diagram showing the system configuration of the content delivery system according to the first embodiment in detail.

FIG. 3 is a schematic diagram showing data structure of a set of contents.

FIG. 4 is a flow chart showing an exemplary selection of content elements by a user in the content delivery system according to the first embodiment.

FIG. 5 is a flow chart continuing from the flow chart shown in FIG. 4.

FIG. 6 is an explanatory diagram illustrating an example of a displayed list of content elements.

FIG. 7 is a flow chart showing an exemplary selection of suitable content elements by an in-store terminal in the content delivery system according to the first embodiment.

FIG. 8 is a flow chart continuing from the flow chart shown in FIG. 7.

FIG. 9 is a block diagram showing the system configuration of a content delivery system according to a second embodiment of the present invention in detail.

FIG. 10 is a flow chart showing an example of how a user is guided to change content elements in the content delivery system according to the second embodiment.

FIG. 11 is a flow chart continuing from the flow chart shown in FIG. 10.

FIG. 12 is a flow chart showing an example of changing what is notified and frequency of notification in Step S220 shown in FIG. 10.

FIG. 13 is a diagram illustrating an example of a displayed menu or content notification information.

FIG. 14 is a flow chart showing an example of changing automatically a set of contents to be delivered in accordance with information on the environment (location) in the content delivery system according to the second embodiment.

FIG. 15 is a flow chart continuing from the flow chart shown in FIG. 14.

FIG. 16 is a flow chart showing an example of how contents are changed in Step S262 shown in FIG. 14.

FIG. 17 is a diagram illustrating an example of displayed contents with large movements.

FIG. 18 is a diagram illustrating an example of displayed contents with small movements.

FIG. 19 is a flow chart showing an example of limiting automatically a set of contents to be delivered in accordance with information on the environment (location) in the content delivery system according to the second embodiment.

FIG. 20 is a flow chart continuing from the flow chart shown in FIG. 19.

FIG. 21 is a flow chart showing an example of regulating changes to content elements composing a set of contents to be delivered in accordance with information on the environment (location) in the content delivery system according to the second embodiment.

FIG. 22 is a flow chart continuing from the flow chart shown in FIG. 21.

FIG. 23 is a flow chart continuing from the flow chart shown in FIG. 22.

FIG. 24 is a flow chart continuing from the flow chart shown in FIG. 23.

FIG. 25 is a diagram illustrating an example of how a screen is divided to simultaneously reproduce server-originated contents and local contents.

FIG. 26 is a diagram illustrating an example of how a screen is divided when a DPF is connected with a network.

FIG. 27 is a diagram illustrating an example of how a screen is divided when a DPF is not connected with a network.

### DETAILED DESCRIPTION OF THE INVENTION

On the following pages, the data reproduction device, the content delivery system and the content delivery method according to the present invention are described in detail based on the preferable embodiments shown in the accompanying drawings.

### First Embodiment

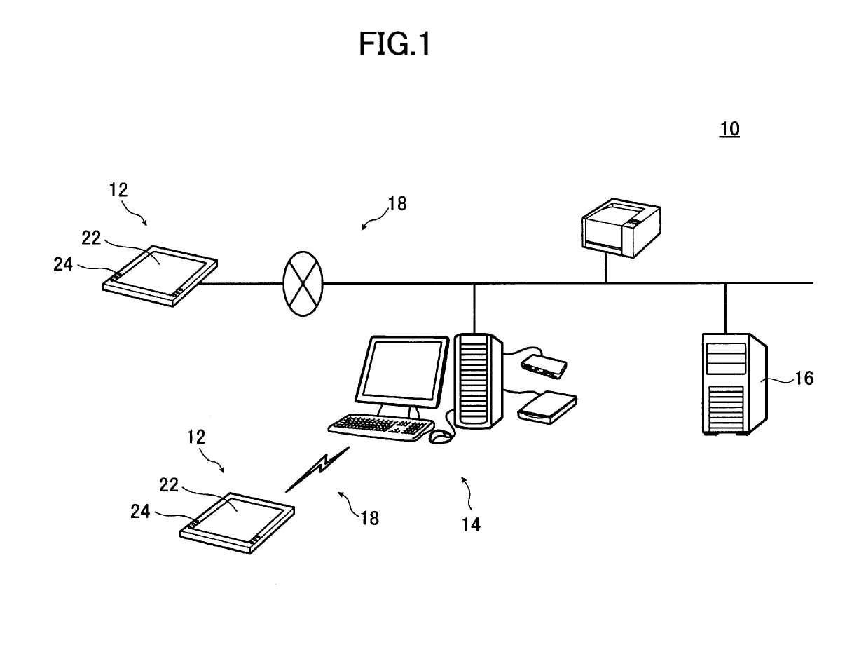

A first embodiment of the present invention is now described. FIG. 1 is a diagram schematically showing the system configuration of a content delivery system 10 according to the first embodiment of the present invention. The content delivery system 10 in FIG. 1 is a client-server type system, comprising a digital photo frame 12 as a data reproduction device, an in-store terminal 14, a billing server 16, and a network 18 for communication. The network 18 may be any known communication means such as a wired LAN, ETHERNET (registered trademark) and a wireless LAN based on IEEE802.11b, -a, -g or -n. Not only a dedicated network but also Internet can be used for this purpose.

The digital photo frame 12 can display a still image, a motion picture, a menu or the like on a display 22 and reproduce music or sounds with a sound reproducer 24. The in-store terminal 14 serves as a server as well as a terminal machine installed at a store, by which possible content elements like still image data, motion picture data, music data and text data may be input, and a set of contents can be generated and delivered. The billing server 16 manages various types of information, i.e., information on billing for a purchase of contents by a user and on loyalty program points earned by a user.

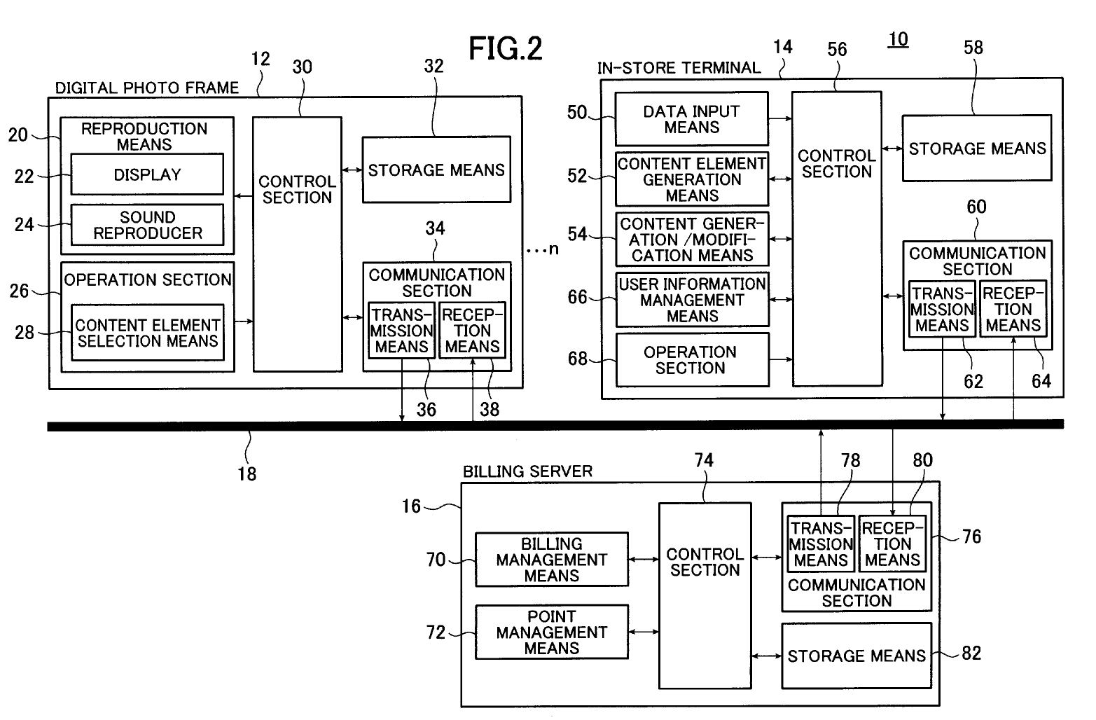

FIG. 2 is a block diagram showing the system configuration of the content delivery system 10 in detail. Following are detailed descriptions of the respective sections shown in FIG. 2.

The digital photo frame 12 includes a reproduction means 20, an operation section 26, a control section 30, a storage means 32, and a communication section 34. The reproduction means 20 comprises the display 22 and the sound reproducer 24; the display 22 can be exemplified by a liquid crystal display and is capable of reproducing a still image, a motion picture, a menu screen, etc., while the sound reproducer 24 can be exemplified by a speaker and is capable of reproducing music and sounds. The display 22 is, for example, disposed on a surface of the digital photo frame 12 in such a manner that the display 12 accounts for the most area of the surface of the digital photo frame 12. With such disposition of the display 12, the displayed images or others can be easily viewed. The sound reproducer 24 is disposed so as to form a sound field suited for viewing contents displayed on the display 22.

The operation section 26 allows a user to operate a menu, etc. on the display 22 or can be used as a content element selection means 28 to select content elements. The operation section 26 comprises switches provided on a casing of the digital photo frame 12 or may be a touch screen on the display 22 by applying the touch-screen technology to the display 22.

The storage means 32 stores a list of content elements and a set of contents that are sent from the in-store terminal 14 described later and may be, for example, a flash memory, a solid state drive (SSD), or a hard disk drive (HDD).

The communication section 34 comprises a transmission means 36 and a reception means 38 and allows communication to exchange operation information, contents, etc. between the digital photo frame 12 and the in-store terminal 14 via the network 18. The transmission means 36 and the reception means 38 are generally disposed in a single piece of hardware, and a network interface card (NIC) for ETHERNET may be used in the wired LAN communication, while a wireless LAN adapter based on IEEE802.11b, -a, -g or -n may be used in the wireless LAN communication. A communication protocol between the digital photo frame 12 and the in-store terminal 14 may be TCP/IP, or alternatively, UDP/IP can be used in order to deliver motion pictures or the like in the streaming delivery.

The control section 30 is connected to and controls the reproduction means 20, the operation section 26, the storage means 32, and the communication section 34. The control section 30, for example, transmits information on operation made with the operation section 26 to the communication section 34 and stores content data that is transmitted from the in-store terminal 14 described later via the communication section 34 in the storage means 32, or sends out the content data to the reproduction means 20. The control section 30 can be a typical single-board computer which has a central processing unit (CPU), a random access memory (RAM), a read only memory (ROM), and an input/output (I/O) therein.

The in-store terminal 14 includes a data input means 50, a content element generation means 52, a content generation/modification means 54, a control section 56, a storage means 58, a communication section 60, a user information management means 66, and an operation section 68. The data input means 50 includes: a wired communication device such as a universal serial bus interface (USBI/F) and an IEEE1394 interface (IEEE1394 I/F); a wireless communication device for infrared communication such as the Infrared Data Association (IrDA) communication and the IrSimple (trademark) communication, Bluetooth (trademark) and a wireless LAN, e.g., Wi-Fi (trademark); a memory card reader; a scanner; and a keyboard, and the data input means 50 allows a user to input pictures and movies that are stored in a digital still camera and a digital video camera, pictures printed on paper, hand-drawn illustrations, text, and others. The keyboard may be used also as an operation section 68 to be described later, while the wireless communication device may be used also as the communication section 60 to be described later.

The content element generation means 52 typically converts various raw data, which was input with the data input means 50, into content elements in a format usable in the content generation/modification means 54 to be described later, and classifies the content elements by their data types to create a database (hereinafter referred to as “content element database”), which is then stored in the storage means 58.

An exemplary data structure of the content element database is shown in Table 2.

TABLE 2

| Content ID | Content Element Type | Data file |
|---|---|---|
| 1 | Temp1 | Temp1A_1.bmp |
| | | Temp1A_2.bmp |
| | Part | Hart_1.bmp |
| | music | PopA_1.mp3 |

The content generation/modification means 54 modifies content elements generated by the content element generation means 52 to generate a set of contents to be transmitted to the digital photo frame 12. For instance, a caption made of text data may be added on a movie, and a frame image may be overlaid on a still image.

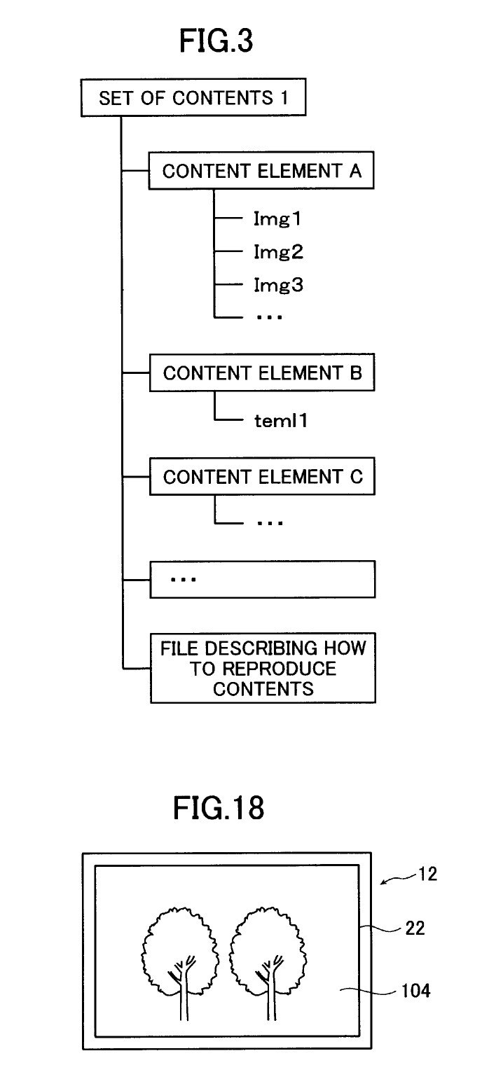

FIG. 3 illustrates a data structure of a set of contents generated by the content generation/modification means 54. A set of contents comprise respective content elements and a file describing how to reproduce the contents. The data of a set of contents forms a tree structure: the set of contents have the content elements and the file describing how to reproduce the contents therebelow. Each content element has its actual data as a still image data or a movie data therebelow. The file describing how to reproduce the contents may contain various indications such as a site, timing, and a rate to reproduce the contents as well as whether or not the content element has an animation for each of the content elements, and the file is written in, for example, Extensible Markup Language (XML) or Synchronized Multimedia Integration Language (SMIL).

The user selects particular information with the content element selection means 28 in the digital photo frame 12, and the selected information is transmitted as content element selection information to the content generation/modification means 54 in the in-store terminal 14 via the network 18.

The content generation/modification means 54 generates a file describing how to reproduce the contents in accordance with the content element selection information, obtains necessary content elements from the above-described content element database, modifies the content elements if necessary, and puts the file describing how to reproduce the contents and the content elements together to transmit them as a set of contents to the digital photo frame 12.

The control section 56 is connected to and controls the data input means 50, the content element generation means 52, the content generation/modification means 54, the storage means 58, the communication section 60 and the user information management means 66. The control section 56 for example transmits various raw data input through the data input means 50 to the content element generation means 52 and then transmits content elements generated by the content element generation means 52 to the storage means 58, or transmits a set of contents generated by the content generation/modification means 54 to the digital photo frame 12 through the communication section 60. The control section 56 comprises a computer having a CPU, a RAM, a ROM, and an I/O therein.

The storage means 58 stores content elements generated from various raw data, a set of contents generated to be transmitted to the digital photo frame 12, user information, etc., and can be an HDD or SSD, for instance.

The communication section 60 comprises a transmission means 62 and a reception means 64 and allows communication to exchange operation information, contents, etc. between the in-store terminal 14 and the digital photo frame 12 via the network 18. The transmission means 62 and the reception means 64 are generally disposed in a single piece of hardware, and a network interface card (NIC) for ETHERNET may be used in the wired LAN communication, while a wireless LAN adapter based on IEEE802.11b, -a, -g or -n may be used in the wireless LAN communication. Here, the communication section 60 utilizing a wireless LAN adapter can directly communicate with the wireless LAN adapter installed as the communication section 34 in the digital photo frame 12, not via the network 18. A communication protocol between the digital photo frame 12 and the in-store terminal 14 may be TCP/IP, or alternatively, UDP/IP can be used in order to deliver motion pictures or the like in the streaming delivery.

Communication with the billing server 16 described later can be made via a wired LAN, while communication with the digital photo frame 12 can be made via a wireless LAN. With this communication design, the digital photo frame 12 may obviate the need to connect with a wired communication, enabling reception of the delivered contents even when being carried.

The user information management means 66 manages information such as a user's name and other base information about the user stored in the storage means 58, his or her order history and the status of his or her order. Upon each order for a particular set of contents, the user information management means 66 updates the user's order status and order history.

The operation section 68 comprises a keyboard, a mouse, etc., by which a user can make an operation to input data and an instruction to generate a set of contents. In addition, text data can be input through the keyboard.

The billing server 16 comprises a billing management means 70, a point management means 72, a control section 74, a communication section 76, and storage means 82. The billing management means 70 manages billing information on the generated set of contents etc. for each user based on the user information managed by the user information management means 66 in the in-store terminal 14. Typically, when a user requests to deliver a set of contents from the in-store terminal 14 to the digital photo frame 12, the user information management means 66 in the in-store terminal 14 adds the delivered set of contents into the order history of the user's information, and the order history with this addition is transmitted by the user information management means 66 in the in-store terminal 14 via the control section 56 and the communication section 60, goes through the network 18, and reaches the billing management means 70 via the communication section 76 and the control section 74 in the billing server 16. The billing management means 70 determines a price to bill the user and the like based on the updated order history, and the price thus determined is stored in the storage means 82 as billing information.

If a content element is purchased in order to replace a part of the content elements of a particular set of contents, it is preferable to bill a price for only the replacing content element.

The point management means 72 receives an order history from the in-store terminal 14 in a similar way of receiving the billing information as described above and manages information on the given or used loyalty program points for each user. In some cases, the point management means 72 gives, for example, twice as many points when a user purchases a particular set of contents. Alternatively, the point management means 72 takes care of managements when, for example, a user uses his or her points to purchase a set of contents.

The control section 74 is connected to and controls the billing management means 70, the point management means 72, the communication section 76 and the storage means 82. For instance, the control section 74 obtains necessary data for billing management, such as order histories, from the in-store terminal 14 via the network 18 with the communication section 76 to send it to the billing management means 70 and sends billing information from the billing management means 70 to the storage means 82. The control section 74 comprises a computer having a CPU, a RAM, a ROM, and an I/O therein.

The communication section 76 comprises a transmission means 78 and a reception means 80 and allows communication with the in-store terminal 14 to exchange user information etc. via the network 18. The transmission means 78 and the reception means 80 are generally disposed in a single piece of hardware and can utilize a wired LAN, a wireless LAN and the like. A communication protocol between the billing server 16 and the in-store terminal 14 is preferably the TCP/IP.

The storage means 82 stores, for instance, billing information and loyalty program points information and may be an HDD, an SSD, etc.

While each of the functions the content delivery system 10 includes has been described above, these functions are realized by the software and hardware resources working together in the system.

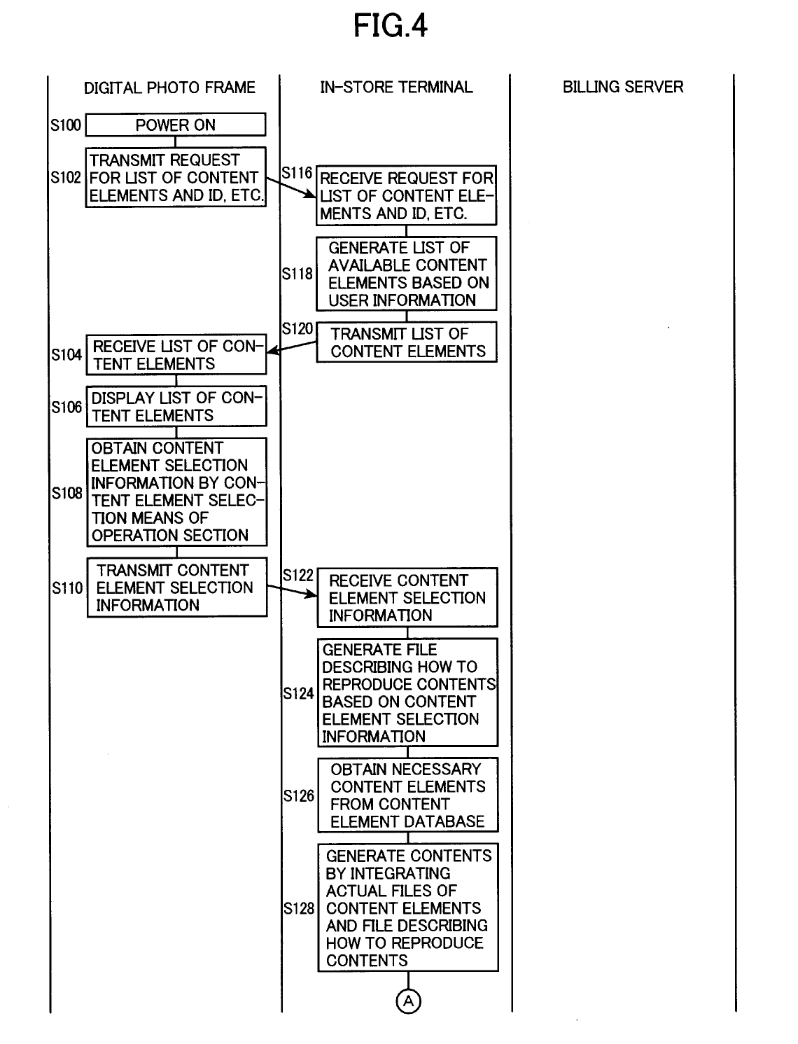

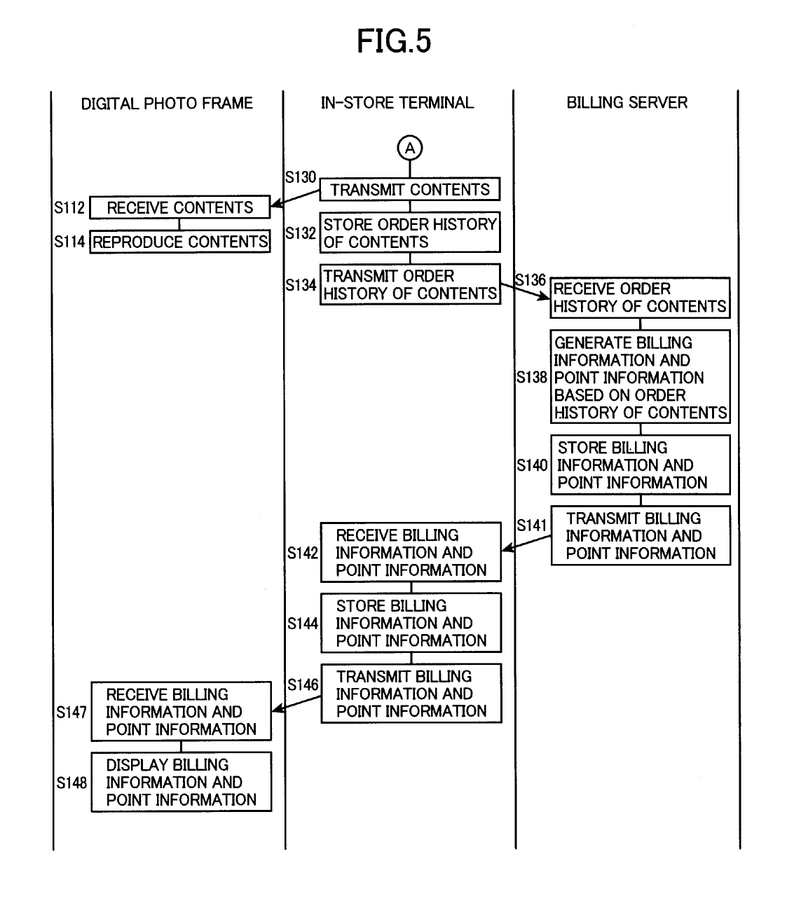

FIG. 4 and FIG. 5 illustrate a flow of a case where a user selects content elements in the content delivery system 10 according to the first embodiment. An example of the content delivery as Example 1 is described below with reference to FIG. 4 and FIG. 5.

### Example 1

First, the digital photo frame 12 is powered on by the user (Step S100).

The digital photo frame 12 is started and then sends a request for a list of content elements to the in-store terminal 14 via the network 18 (Step S102). Together with the request, the digital photo frame 12 may also send information to identify the user, i.e., identification data (ID), to allow the in-store terminal 14 to determine whose digital photo frame 12 is requesting a list of content elements.

The in-store terminal 14 receives the request for a list of content elements together with the ID of the digital photo frame 12 or the like sent by the digital photo frame 12 (Step S116), retrieves the user information stored in the storage means 58 based on the received ID of the digital photo frame 12 or the like and generates a list of available content elements in accordance with the user information (Step S118). The available content elements include those the user originally owned and input into the in-store terminal 14 in advance so as to register them in the content element database and those the store originally owned and registered in the content element database.

The in-store terminal 14 sends the generated list of content elements to the digital photo frame 12 via the network 18 (Step S120).

The digital photo frame 12 receives the list of content elements (Step S104) and displays the list on the display 22 of the reproduction means 20 (Step S106). Here, the sound reproducer 24 may play a sound in order to let the user know that the list is displayed.

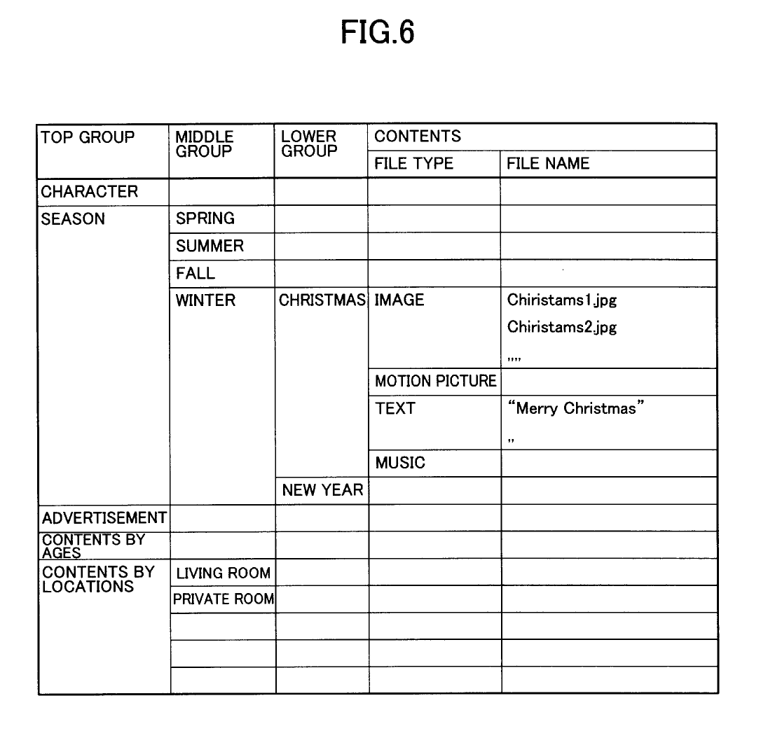

An example of a displayed list of content elements is shown in FIG. 6. The example of a displayed list of content elements in FIG. 6 includes a top group, a middle group and a lower group, each of which lists respective contents such as a still image, a motion picture, text and music. A part of or the entire of the list of content elements may be displayed.

The user selects content elements the user wishes to reproduce out of the list of content elements on the display 22 by using the content element selection means 28 of the operation section 26. Having a touch screen on the display 22 as the operation section 26, for example, the display 22 may display screens with which the user can select from the list of content elements, thereby providing the content element selection means 28.

The digital photo frame 12 obtains content element selection information on the content elements selected with the content element selection means 28 (Step S108) and sends the information to the in-store terminal 14 via the network 18 (Step S110).

The in-store terminal 14 receives the content element selection information in the reception means 64 of the communication section 60 (Step S122), and the content element selection information is sent to the content generation/modification means 54. The content generation/modification means 54 generates a file describing how to reproduce the contents based on the content element selection information (Step S124).

The content generation/modification means 54 takes necessary content elements out of the content element database (Step S126) and generates a set of contents to transmit to the digital photo frame 12 based on actual files of the content elements stored in the storage means 58 and the file describing how to reproduce the contents (Step S128).

The in-store terminal 14 transmits the thus generated set of contents to the digital photo frame 12 via the network 18 (Step S130). In this step, contents of a movie may be streamed by means of UDP/IP. Streaming delivery can sequentially reproduce data in order of reception, resulting in reduction of the user's waiting time for reproduction of the contents.

The digital photo frame 12 receives the set of contents in the reception means 38 of the communication section 34 (Step S112) and sends the contents to the control section 30. The control section 30 stores the contents in the storage means 32 when necessary or, in streaming delivery, does not store but transmits the contents to the reproduction means 20 to allow the contents to be instantly reproduced by the display 22 and the sound reproducer 24 (Step S114).

Upon completion of delivery of the set of contents to the digital photo frame 12, the in-store terminal 14 stores an order history of the contents in the storage means 58 (Step S132) and further transmits the order history to the billing server 16 via the network 18 (Step S134).

The billing server 16 receives the order history of the contents in the reception means 80 of the communication section 76 (Step S136) and forwards the order history to the control section 74. The control section 74 transmits the order history of the contents to the billing management means 70 and the point management means 72 to generate the billing information in the billing management means 70 and information on loyalty program points in the point management means 72 (Step S138). The billing information and the point information are stored in the storage means 82 (Step S140) and are additionally transmitted to the in-store terminal 14 via the network 18 (Step S141). The billing information and the point information may be a conversion result of the loyalty program points when the user uses his or her loyalty program points for the order and thus is not billed.

The in-store terminal 14 receives the billing information and the point information in the reception means 64 of the communication section 60 (Step S142) and forwards them to the control section 56. The control section 56 then sends the billing information and the point information to the storage means 58 to store them (Step S144). The in-store terminal 14 sends the billing information and the point information to the digital photo frame 12 via the network 18 on particular occasions such as completion of content reproduction by the digital photo frame 12 (Step S146).

The digital photo frame 12 receives the billing information and the point information (Step S147) to display them on the display 22 of the reproduction means 20 (Step S148).

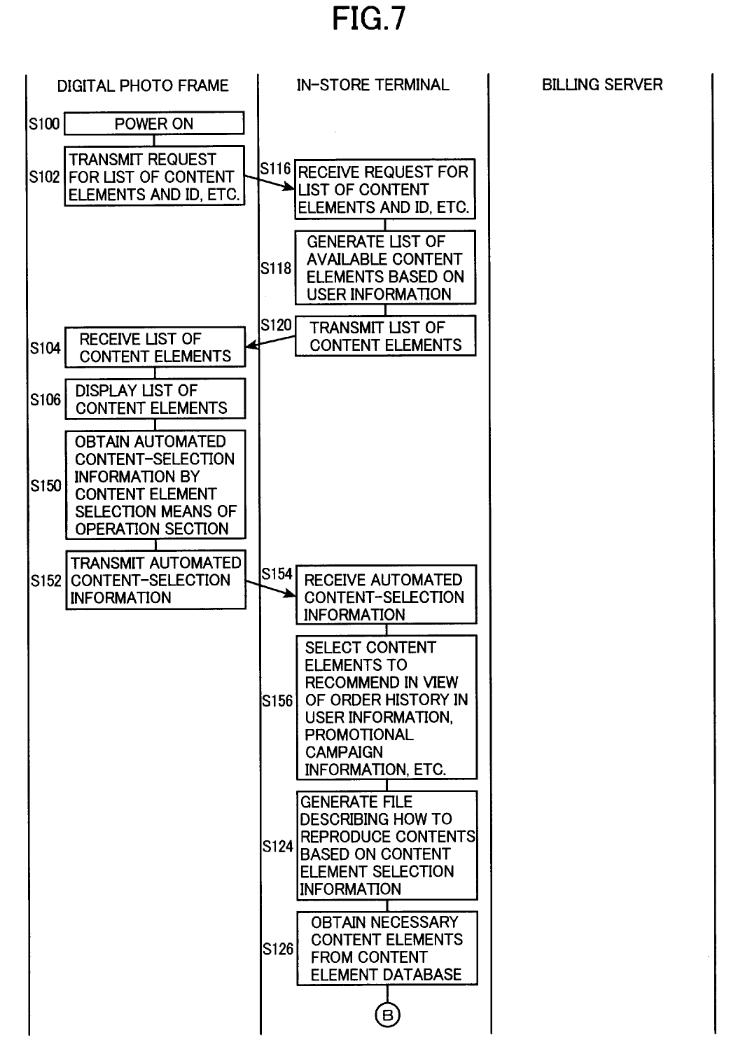

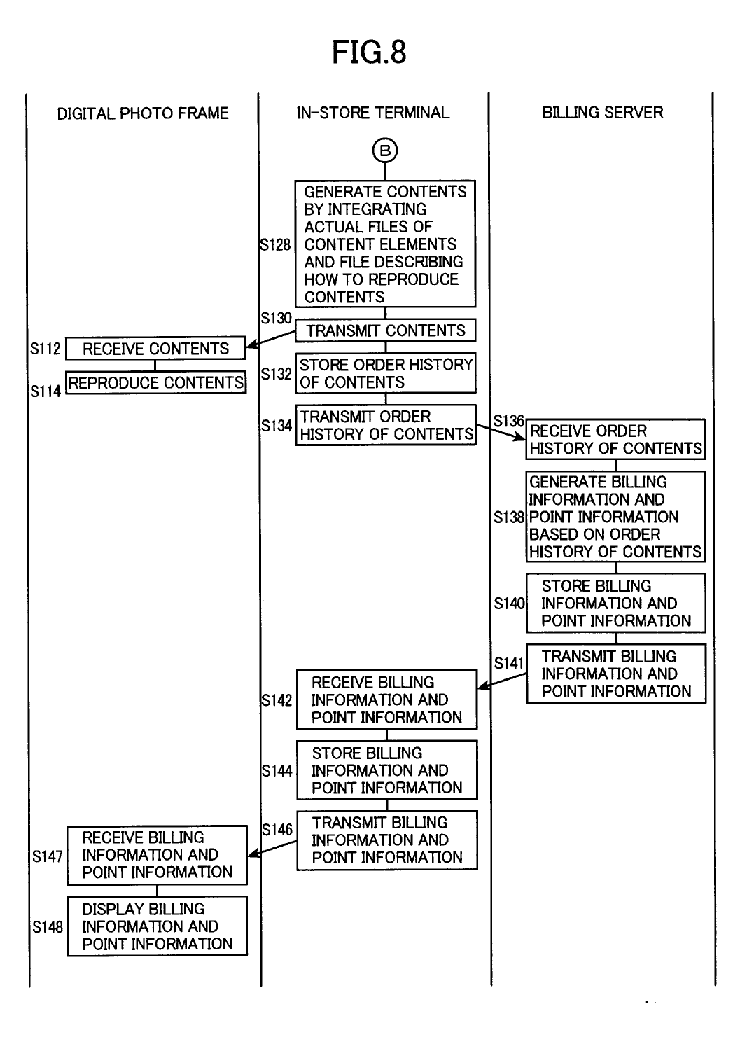

Next, FIG. 7 and FIG. 8 illustrate a flow of a case where not a user but the in-store terminal 14 selects appropriate content elements in the content delivery system 10 according to the first embodiment. Another example of the content delivery as Example 2 is described below with reference to FIG. 7 and FIG. 8.

### Example 2

First, the digital photo frame 12 is powered on by the user (Step S100).

The digital photo frame 12 is started and then sends a request for a list of content elements to the in-store terminal 14 via the network 18 (Step S102). Together with the request, the digital photo frame 12 may also send information to identify the user, i.e., ID, to allow the in-store terminal 14 to determine whose digital photo frame 12 is requesting a list of content elements.

The in-store terminal 14 receives the request for a list of content elements together with the ID of the digital photo frame 12 or the like sent by the digital photo frame 12 (Step S116), retrieves the user information stored in the storage means 58 based on the received ID of the digital photo frame 12 or the like and generates a list of available content elements in accordance with the user information (Step S118). The available content elements include those the user originally owned and input into the in-store terminal 14 in advance so as to register them in the content element database and those the store originally owned and registered in the content element database.

The in-store terminal 14 sends the generated list of content elements to the digital photo frame 12 via the network 18 (Step S120).

The digital photo frame 12 receives the list of content elements (Step S104) and displays the list on the display 22 of the reproduction means 20 (Step S106). Here, the sound reproducer 24 may play a sound in order to let the user know that the list is displayed.

The user may choose an option of “automated selection,” which is displayed on the display 22 in addition to the list of content elements, by the content element selection means 28 of the operation section 26 in order to leave the content selection to the in-store terminal 14.

The digital photo frame 12 obtains the automated content-selection information chosen by the content element selection means 28 (Step S150) to send it to the in-store terminal 14 via the network 18 (Step S152).

The in-store terminal 14 receives the automated content-selection information in the reception means 64 of the communication 60 (Step S154) and forwards the information to the content generation/modification means 54. Based on the automated content-selection information, the content generation/modification means 54 selects content elements to recommend to the user in view of the user's attribute, order history, promotional campaign information, etc. and to generate the file describing how to reproduce the contents (Step S156). In this step, a combination of content elements composing a particular set of contents already in the order history should be given a lower degree of recommendation in order to prevent duplicated delivery of previously delivered contents in a past order.

The content generation/modification means 54 takes necessary content elements out of the content element database (Step S126) and generates a set of contents to transmit to the digital photo frame 12 based on actual files of the content elements stored in the storage means 58 and the file describing how to reproduce the contents (Step S128).

The in-store terminal 14 transmits the thus generated set of contents to the digital photo frame 12 via the network 18 (Step S130). In this step, contents of a movie may be streamed by means of UDP/IP. Streaming delivery can sequentially reproduce data in order of reception, resulting in reduction of the user's waiting time for reproduction of the contents.

The digital photo frame 12 receives the set of contents in the reception means 38 of the communication section 34 (Step S112) and forwards the contents to the control section 30. The control section 30 stores the contents in the storage means 32 when necessary or, in streaming delivery, does not store but transmits the contents to the reproduction means 20 to allow the contents to be instantly reproduced by the display 22 and the sound reproducer 24 (Step S114).

Upon completion of delivery of the set of contents to the digital photo frame 12, the in-store terminal 14 stores an order history of the contents in the storage means 58 (Step S132) and further transmits the order history to the billing server 16 via the network 18 (Step S134).

The billing server 16 receives the order history of the contents in the reception means 80 of the communication section 76 (Step S136) and forwards the order history to the control section 74. The control section 74 transmits the order history of the contents to the billing management means 70 and the point management means 72 to generate the billing information in the billing management means 70 and information on loyalty program points in the point management means 72 (Step S138). The billing information and the point information are stored in the storage means 82 (Step S140) and are additionally transmitted to the in-store terminal 14 via the network 18 (Step S141). The billing information and the point information may be a conversion result of the loyalty program points when the user uses his or her loyalty program points for the order and thus is not billed.

The in-store terminal 14 receives the billing information and the point information in the reception means 64 of the communication section 60 (Step S142) and forwards them to the control section 56. The control section 56 then sends the billing information and the point information to the storage means 58 to store them (Step S144). The in-store terminal 14 sends the billing information and the point information to the digital photo frame 12 via the network 18 on particular occasions such as completion of content reproduction in the digital photo frame 12 (Step S146).

The digital photo frame 12 receives the billing information and the point information (Step S147) to display them on the display 22 of the reproduction means 20 (Step S148).

### Second Embodiment

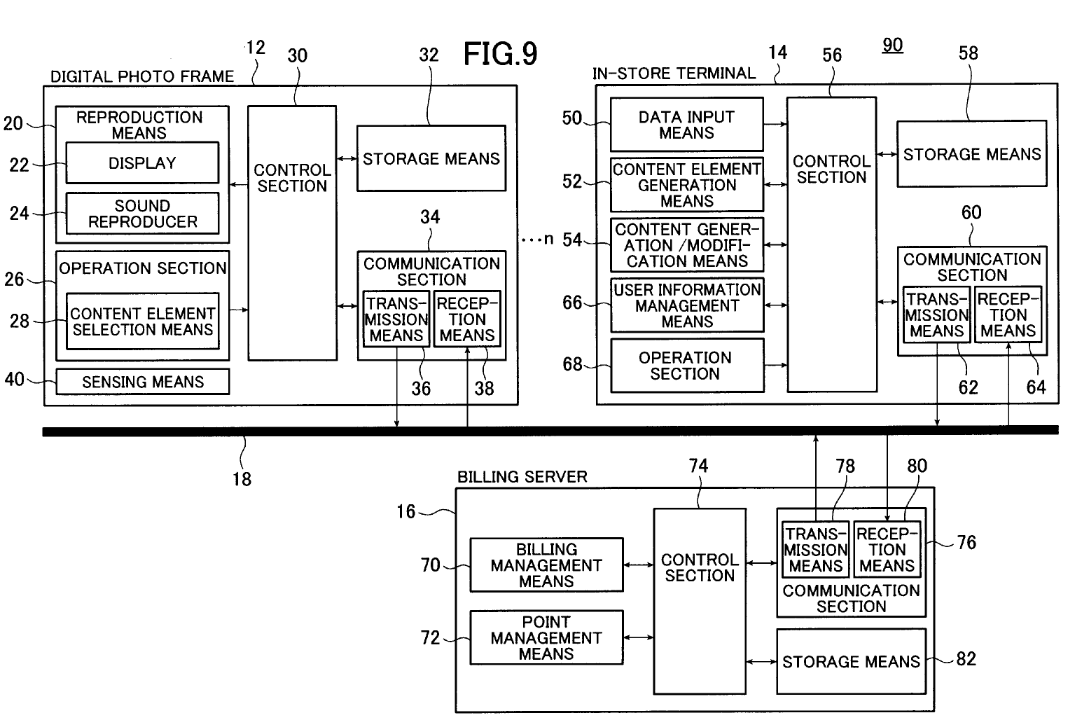

A second embodiment of the present invention is described in the following pages. FIG. 9 is a block diagram showing a content delivery system 90 according to the second embodiment of the present invention. The content delivery system 90 has the similar construction to that of the content delivery system 10 according to the first embodiment shown in FIG. 1 and FIG. 2, except for sensing means 40 additionally included in the digital photo frame 12. In the content delivery system 90 in FIG. 9, the constitutional elements commonly included in the content delivery system 10 shown in FIG. 2 share the same reference numerals, and their detailed descriptions are omitted. The following description mainly describes differences between the content delivery system 90 according to the second embodiment and the content delivery system 10 shown in FIG. 2.

The sensing means 40 serves to sense the environment surrounding the digital photo frame 12. A photoresistor or photodiode for sensing brightness, an infrared sensor for detecting a human body, or a microphone for collecting sounds in its surroundings, for instance, can be used as the sensing means 40. A global positioning system (GPS) may also be used to find the latitude and longitude of the digital photo frame 12 if the digital photo frame 12 is located outdoors.

When the digital photo frame 12 is used indoors, a device for detecting a room size such as an ultrasonic sensor and laser radar may be used to assume in what type of room the digital photo frame 12 is located. Such assumption can be made based on the size and shape of the room; for example, a large room having a square or rectangle shape can be assumed to be a living room, or a room having an elongated shape can be assumed to be a passage or an entrance hall. And, a highly sensible GPS can be used in a building highly permeable to radio waves.

In addition, a small camera may be attached to the digital photo frame 12 to detect its surroundings. The camera may also detect the brightness in the room, or images taken by the camera may be analyzed to know the type of room in which the digital photo frame 12 is located.

Moreover, for finding the more exact location within a house, for instance, the locating process described below can be adopted.

(1) Location Detection with Wireless LAN

The digital photo frame 12 adopting the communication section 34 based on a wireless LAN for communicating contents, etc., can detect its location by means of the wireless LAN.

A wireless LAN base unit or base station to communicate with the digital photo frame 12 is installed within a house. By measuring the intensity of radio waves emitted by the digital photo frame 12 and received by the wireless LAN base unit or base station, an approximate distance between the wireless LAN base unit or base station and the digital photo frame 12 can be found. Having in the digital photo frame 12 a floor plan or the like of the house stored and the location of the wireless LAN base unit or base station in the house registered beforehand, the distance between the wireless LAN base unit or base station and the digital photo frame 12 is subjected to map-matching based on the floor plan to assume in which room the digital photo frame 12 is located.

When two or more wireless LAN base units or base stations can be installed, the location of the digital photo frame 12 can be found based on differences in propagation time of the radio waves travelling between each of the wireless LAN base units or base stations and the digital photo frame 12.

Furthermore, the more accurate detection of the location can be realized by combining with other sensor information.

(2) Location Detection with an Acceleration Sensor

First, a reference point for location detection is given in a house. An example thereof is a location where a cradle or the like to be connected with the network 18 for delivering contents to the digital photo frame 12 is placed. An acceleration sensor as the sensing means 40 is provided to the digital photo frame 12 and resets movement information in the state the digital photo frame 12 is connected to the cradle.

As the digital photo frame 12 is carried by the user, acceleration is generated, and the acceleration is detected by the acceleration sensor. The acceleration thus detected is subjected to second-order integration to obtain a distance by which the digital photo frame 12 is moved, and map-matching is performed based on the floor plan. As a result, it can be assumed in which room the digital photo frame 12 is located.

The acceleration sensor preferably detects in two or more axes in order to detect acceleration along the horizontal plane. In order to also detect a shift in the vertical direction, a three-axes acceleration sensor is preferably used. In addition, by also including a magnetic direction sensor to find the direction to be shifted and subjecting the direction information together with acceleration information obtained by the acceleration sensor to map-matching, the location of the digital photo frame 12 can be assumed more accurately.

(3) Location Detection with an IC Tag

An IC tag having a unique identification, for example, is installed in a house. An IC tag reader is provided to the digital photo frame 12 as the sensing means 40. The digital photo frame 12 is provided with a table containing information on each room of the house to which a particular identification is preliminarily assigned. When the user enters, for example, a living room while carrying the digital photo frame 12, the IC tag is read and the table is referred to on the basis of the identification information of the IC tag, to thereby determine that the digital photo frame 12 is located in the living room.

The content element database generated by the content element generation means 52 additionally includes information on the surroundings of the digital photo frame 12, i.e., environmental information of the digital photo frame 12. For possibly changing the data file of the content elements to be used depending on the surroundings of the digital photo frame 12, the content element database has such a structure that a column of surroundings-identifiers providing the environmental information is included as shown in Table 3. With the database of this structure, a data file of the content elements suitable for the environment (location) of the digital photo frame 12 can be used.

TABLE 3

| Content ID | Content element type | s-Identifiers | Data file |
|---|---|---|---|
| 1 | Temp1 | A | Temp1A_1.bmp |
| | | B | Temp1A_2.bmp |
| | Part | A | Hart_1.bmp |
| | music | A | PopA_1.mp3 |

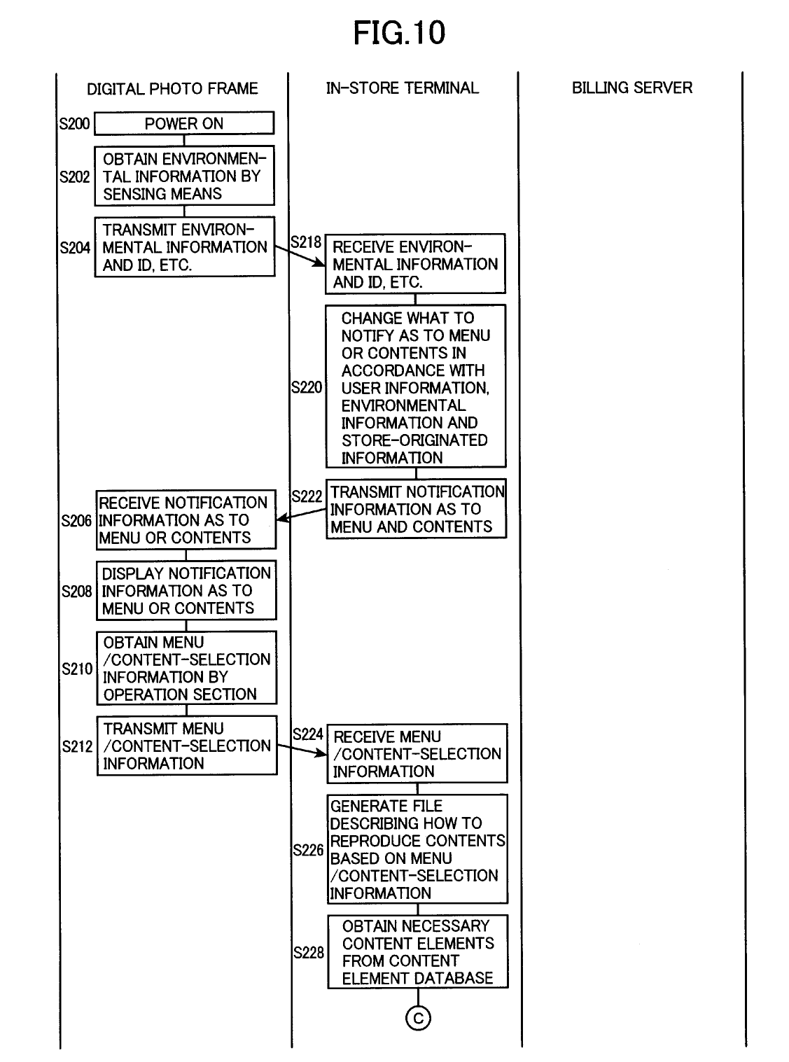

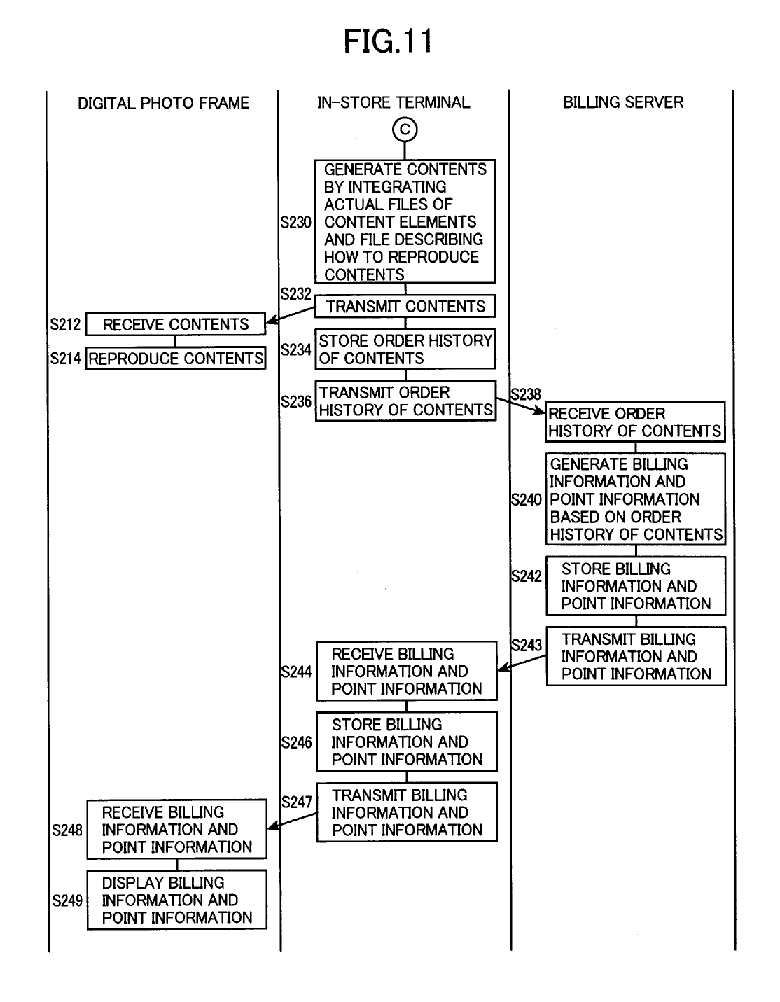

FIG. 10 and FIG. 11 illustrate a flow of a case where a menu or a set of contents in accordance with the environmental (location) information is sent to let the user change contents according to the second embodiment of the content delivery system 90. An example of the content delivery as Example 3 is described below with reference to FIG. 10 and FIG. 11.

### Example 3

First, the digital photo frame 12 is powered on by the user (Step S200).

The digital photo frame 12 is started and then obtains the environmental information by sensing means 40 (Step S202). The environmental information thus obtained is transmitted to the in-store terminal 14 via the network 18 (Step S204). Together with the environmental information, the digital photo frame 12 may also send information to identify the user such as the ID of the digital photo frame 12, thereby allowing the in-store terminal 14 to determine whose digital photo frame 12 has sent the environmental information.

The in-store terminal 14 receives the environmental information together with, for example, the ID of the digital photo frame 12 transmitted by the digital photo frame 12 (Step S218), retrieves the user information stored in the storage means 58 based on the received ID of the digital photo frame 12 or the like and changes what to notify and a frequency to notify the user as to the menu or a set of contents in accordance with the user information, environmental information and store-originated information such as event information stored in the storage means 58 (Step S220).

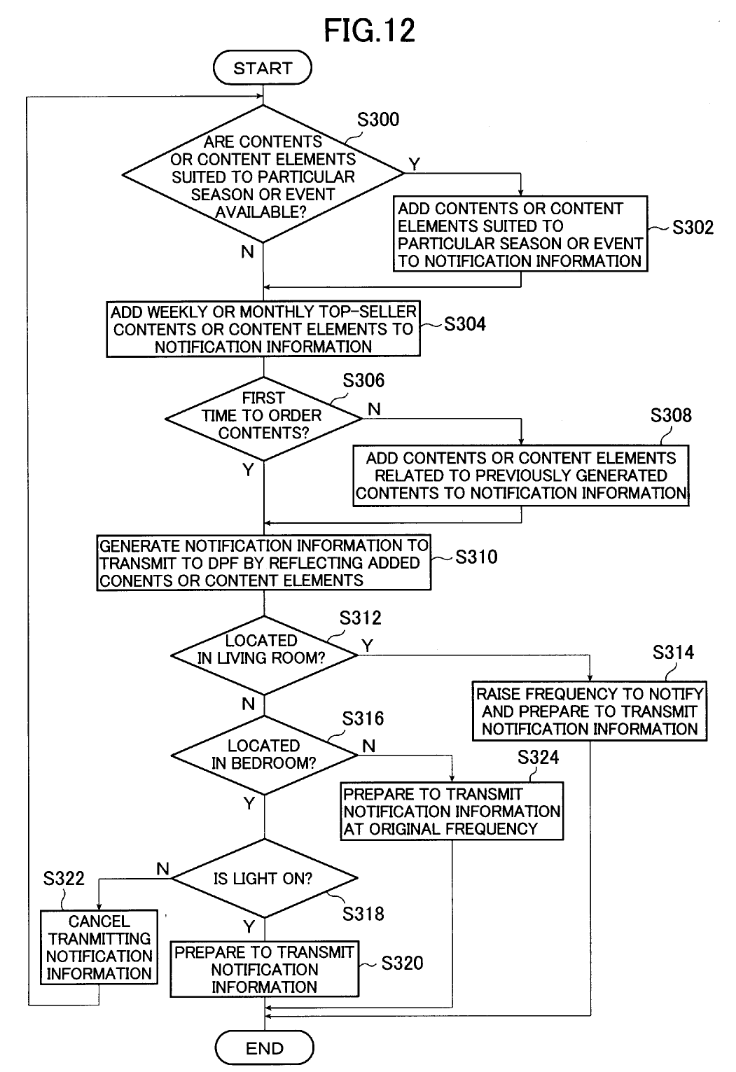

An example of changing what to notify as well as the frequency to notify the user in Step S220 is illustrated by the flow chart in FIG. 12.

First, it is determined whether store-originated information, e.g., contents or content elements suited to a particular season or event such as Christmas is available (Step S300), and if YES, the contents or content elements suited to the particular season or event are added to notification information (Step S302). Next, weekly or monthly top-seller contents or content elements based on the whole order situation including those from all other users are added to the notification information as another store-originated information (Step S304). Then, it is determined whether the user has ordered any set of contents before (Step S306), and if this is the case, any set of contents or content elements relating to the previously generated set of contents are added to the notification information (Step S308).

These additional contents or content elements are reflected in generating the notification information to be transmitted to the digital photo frame 12 (Step S310).

The location of the digital photo frame 12 is determined based on the environmental information (Step S312). In the case where the digital photo frame 12 is located in a living room, the whole family possibly views the delivered contents so that notification information is prepared to be transmitted to the digital photo frame 12 at a raised frequency (Step S314).

In the case where the digital photo frame is not located in a living room but in a bedroom (Step S316), it is determined whether the light in the bedroom is on based on brightness information included in environmental information transmitted by the digital photo frame 12 (Step S318). If the light is on, notification information to be transmitted is prepared (Step S320), or if the light is turned off, it is presumed that the user is in sleep, and hence notification information is not transmitted (Step S322).

In the case where the digital photo frame 12 is located neither in a living room nor in a bedroom, notification information is prepared to be transmitted at the frequency originally set (Step S324).

The in-store terminal 14 transmits the notification information as to a menu or a set of contents prepared in Step S220 to the digital photo frame 12 via the network 18 (Step S222).

The digital photo frame 12 receives the notification information as to a menu or a set of contents (Step S206) and displays the information on the display 22 of the reproduction means 20 (Step 208). Here, the sound reproducer 24 may play a sound in order to let the user know that the notification information as to the menu or a set of contents is displayed.

The user selects what the user desires to reproduce from a menu or contents included in the notification information displayed on the display 22 by using the operation section 26. An example of the operation section 26 is a touch screen provided on the display 22.

The digital photo frame 12 now has the selected menu or contents by the operation section 26 as menu/content-selection information (Step S210) and transmits the menu/content-selection information to the in-store terminal 14 via the network 18 (Step S212).

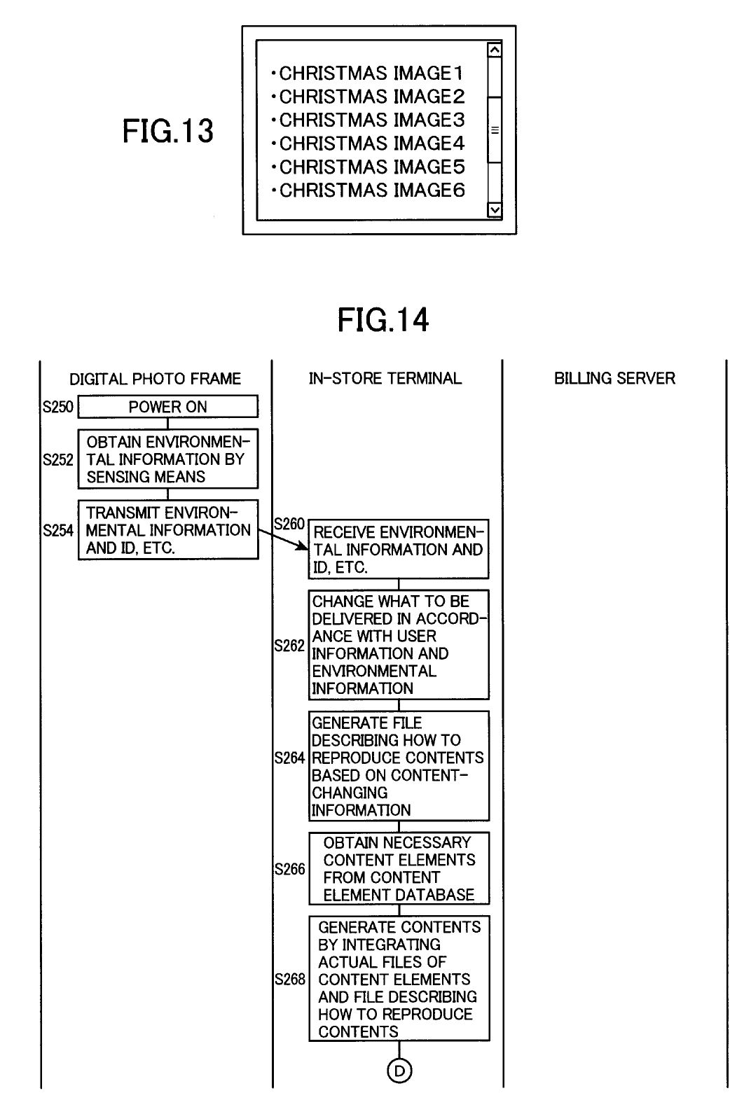

The menu or content notification information displayed as shown in FIG. 13 is preferably a list of suitable contents selected on the basis of the environmental information of the digital photo frame 12. Here, in the case where the list of contents to be displayed cannot fit in the screen, the screen may be moved by means of a scroll bar or the like. The content notification information (the list) may be displayed not only in the form of text but also in the form of thumbnail pictures.

In addition, the content notification information (the list) to be displayed need not to include all of the contents in a certain group (such as a group of “Christmas images”); the top ten images in the sales ranking may be displayed, or the number of contents to be displayed may be determined in accordance with the size of the display 22 of the digital photo frame 12, for example.

The in-store terminal 14 receives the menu/content-selection information in the reception means 64 of the communication section 60 (Step S224), and the menu/content-selection information is forwarded to the content generation/modification means 54. The content generation/modification means 54 generates a file describing how to reproduce the contents based on the received menu/content-selection information (Step S226).

The content generation/modification means 54 takes necessary content elements out of the content element database (Step S228) and generates a set of contents to transmit to the digital photo frame 12 based on actual files of the content elements stored in the storage means 58 and the file describing how to reproduce the contents (Step S230).

The in-store terminal 14 transmits the generated contents to the digital photo frame 12 via the network 18 (Step S232). Note that content elements may be transmitted to the digital photo frame 12 via the network as they are, without being modified or changed.

The digital photo frame 12 receives the set of contents in the reception means 38 of the communication section 34 (Step S214) and forwards the contents to the control section 30. The control section 30 stores the contents in the storage means 32 when necessary or, in streaming delivery, does not store but transmits the contents to the reproduction means 20 to allow the contents to be instantly reproduced by the display 22 and the sound reproducer 24 (Step S216).

Upon completion of delivery of the set of contents to the digital photo frame 12, the in-store terminal 14 stores an order history of the contents in the storage means 58 (Step S234) and further transmits the order history to the billing server 16 via the network 18 (Step S236).

The billing server 16 receives the order history of the contents in the reception means 80 of the communication section 76 (Step S238) and forwards the order history to the control section 74. The control section 74 transmits the order history of the contents to the billing management means 70 and the point management means 72 to generate the billing information in the billing management means 70 and information on loyalty program points in the point management means 72 (Step S240). The billing information and the point information are stored in the storage means 82 (Step S242) and are additionally transmitted to the in-store terminal 14 via the network 18 (Step S243). The billing information and the point information may be a conversion result of the loyalty program points when the user uses his or her loyalty program points for the order and thus is not billed.

The in-store terminal 14 receives the billing information and the point information in the reception means 64 of the communication section 60 (Step S244) and forwards them to the control section 56. The control section 56 then sends the billing information and the point information to the storage means 58 to store them (Step S246). The in-store terminal 14 sends the billing information and the point information to the digital photo frame 12 via the network 18 on particular occasions such as completion of content reproduction by the digital photo frame 12 (Step S247).

The digital photo frame 12 receives the billing information and the point information (Step S248) to display them on the display 22 of the reproduction means 20 (Step S249).

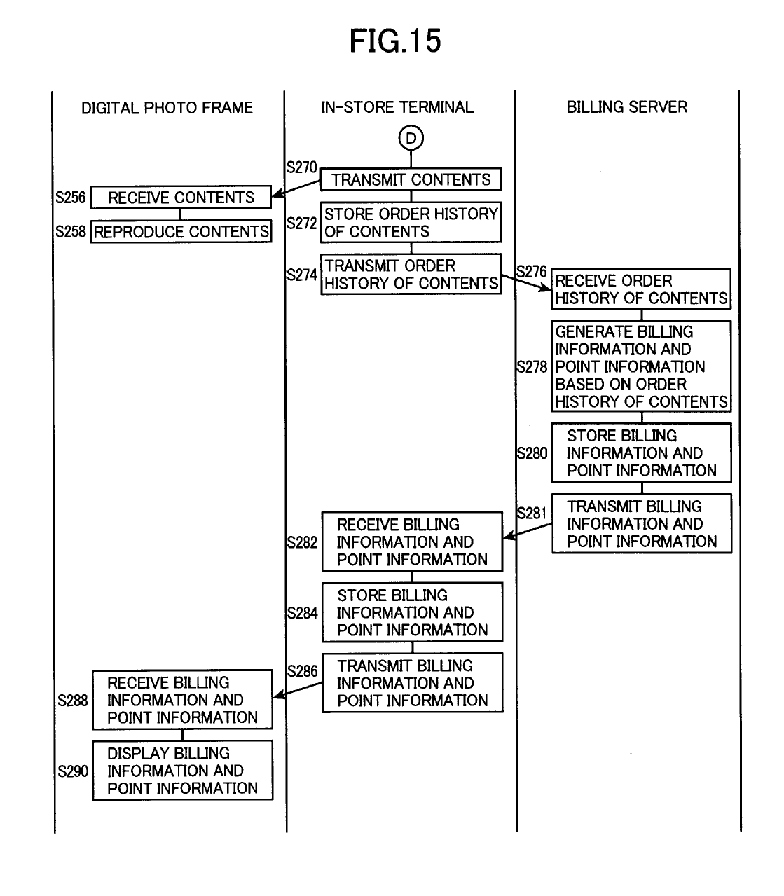

Next, FIG. 14 and FIG. 15 illustrate a flow of a case where a set of contents to be delivered is automatically changed in accordance with the environmental (location) information in the content delivery system 90 according to the second embodiment. An example of the content delivery as Example 4 is described below with reference to FIG. 14 and FIG. 15.

### Example 4

First, the digital photo frame 12 is powered on by the user (Step S250).

The digital photo frame 12 is started and then obtains the environmental information by sensing means 40 (Step S252). The environmental information thus obtained is transmitted to the in-store terminal 14 via the network 18 (Step S254). Together with the environmental information, the digital photo frame 12 may also send information to identify the user such as the ID of the digital photo frame 12, thereby allowing the in-store terminal 14 to determine whose digital photo frame 12 has sent the environmental information.

The in-store terminal 14 receives the environmental information together with, for example, the ID of the digital photo frame 12 transmitted by the digital photo frame 12 (Step S260), retrieves the user information stored in the storage means 58 based on the received ID of the digital photo frame 12 or the like and changes a set of contents to deliver in accordance with the user information and the environmental information (Step S262). In this step, a combination of content elements composing a particular set of contents already in the order history should be given a lower degree of recommendation in order to prevent duplicated delivery of previously delivered contents in a past order.

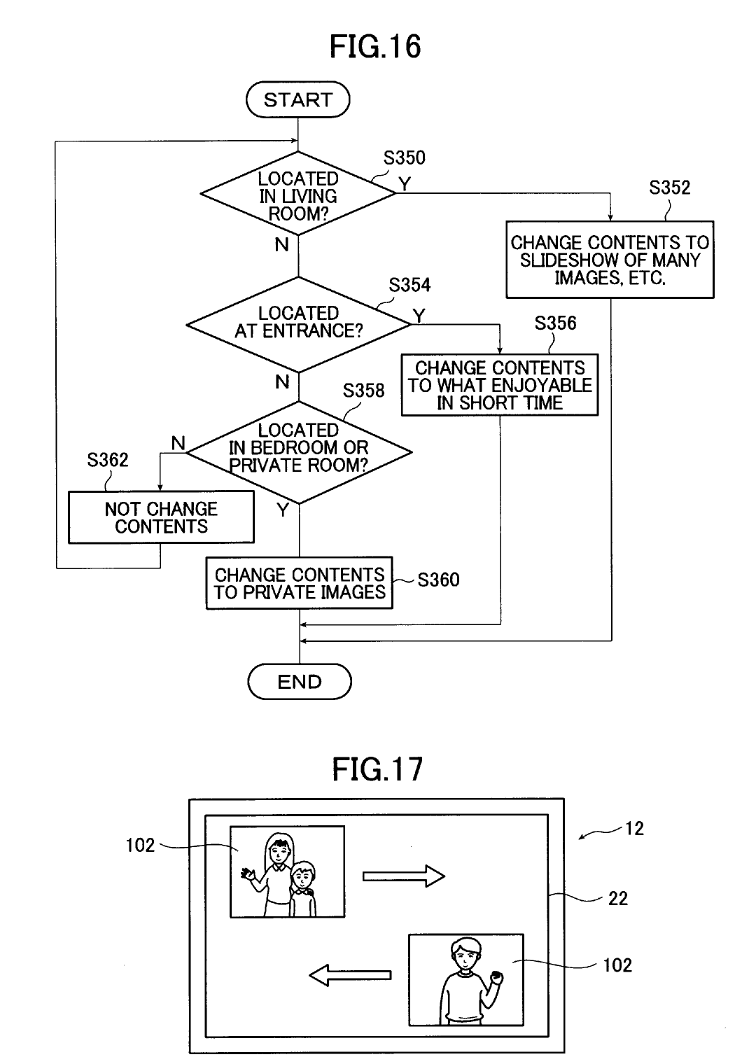

An example of changing the set of contents to deliver in Step S262 is illustrated by the flow chart in FIG. 16.

TABLE 4

| | Environmental information (persons) | | | |
|---|---|---|---|---|
| Location | Number of people | Action | Posture | Examples of created contents |
| Passage | One to two | Walking | Standing | (Ex. 1) What is displayed is switched |
| | | | | at specified intervals (frequent |
| | | | | switching of display is inappropriate |
| | | | | for a walking viewer). |
| | | | | (Ex. 2) What is displayed is switched |
| | | | | every time a person(s) passes by. |
| Living room | One or more | Mainly | Sitting on chair | Contents to be enjoyed by many people |
| Private room | One | still | Sitting on chair | Contents suitable for an individual |
| Japanese room | One or more | | Sitting on floor | Mainly Japanese contents (templates, |
| | | | (Tatami mat) | background music, etc.) |

First, the location of the digital photo frame 12 is determined based on the environmental information (Step S350). If the digital photo frame 12 is located in a living room, the contents are supposedly viewed by many people, and a lot of images are displayed. Hence, the contents are changed to be suitable for a reproduction technique such as a slideshow with a number of images, by which viewers can enjoy viewing images as they change successively (Step S352). In addition, a reproduction technique which is capable of displaying two or more images at a time may be used. Images may be likewise reproduced in a Japanese room, or Japanese contents may be specifically chosen for a Japanese room.

In the case where the digital photo frame 12 is located not in a living room but at an entrance or a passage of the house (Step S354), viewing time tends to be short, so the contents are changed to those that can be enjoyed in a short period of time (Step S356). Examples of such reproduction technique include one by which the displayed images are replaced by others every time a person passes by the digital photo frame 12 and one by which a large image is displayed.

In the case where the digital photo frame 12 is not located either in a living room, at an entrance or a passage of the house but in a bedroom or a private room (Step S358), the contents are changed to those composed of private images to be viewed by one person or a few persons (Step S360).

In the case where the digital photo frame 12 is located at a place other than any one of the above-described rooms and places, the contents are not changed (Step S362).

Here, additional exemplary differences in the contents to be reproduced between a living room and a private room are shown in Table 5.

TABLE 5

| | Living room | Private room |
|---|---|---|
| Concept | To be enjoyed by many people | To be suitable for an individual |
| What to be | Based on people in the room | Determined based on the reproduction |
| reproduced | (Viewers may vary depending on the | history (delivery of duplicated |
| | day or time. By determining the | contents should be avoided, since |
| | current viewer, i.e., mainly, a | the viewer is always the same.) |
| | mother during day time and children | |
| | in the evening, best suited | |
| | contents are delivered.) | |
| Display | Large images for easy viewing | Display with “quick movements” or |
| format | (Viewers may be distant from DPF; | “fine details” to some extent is |
| | display should be viewable from a | acceptable (DPF for personal use may |
| | distance.) | be viewed on hand.) |
| Images to be | Public (Images that can be seen by | Private |
| displayed | others.) | |

The content generation/modification means 54 in the in-store terminal 14 generates a file describing how to reproduce the contents (Step S264) based on the content-changing information determined in Step S262.

The content generation/modification means 54 takes necessary content elements out of the content element database (Step S266) and generates a set of contents to transmit to the digital photo frame 12 based on actual files of the content elements stored in the storage means 58 and the file describing how to reproduce the contents (Step S268).

The in-store terminal 14 transmits the set of contents thus generated to the digital photo frame 12 via the network 18 (Step S270).

The digital photo frame 12 receives the contents in the reception means 38 of the communication section 34 (Step S256) and sends the contents to the control section 30. The control section 30 stores the contents in the storage means 32 when necessary or, in streaming delivery, does not store but transmits the contents to the reproduction means 20 to allow the contents to be instantly reproduced by the display 22 and the sound reproducer 24 (Step S258).

Upon completion of delivery of the set of contents to the digital photo frame 12, the in-store terminal 14 stores an order history of the contents in the storage means 58 (Step S272) and further transmits the order history to the billing server 16 via the network 18 (Step S274).

The billing server 16 receives the order history of the content in the reception means 80 of the communication section 76 (Step S276) and forwards the order history to the control section 74. The control section 74 transmits the order history of the contents to the billing management means 70 and the point management means 72 to generate the billing information in the billing management means 70 and information on loyalty program points in the point management means 72 (Step S278). The billing information and the point information are stored in the storage means 82 (Step S280) and are additionally transmitted to the in-store terminal 14 via the network 18 (Step S281). The billing information and the point information may be a conversion result of the loyalty program points when the user uses his or her loyalty program points for the order and thus is not billed.

The in-store terminal 14 receives the billing information and the point information in the reception means 64 of the communication section 60 (Step S282) and forwards them to the control section 56. The control section 56 then sends the billing information and the point information to the storage means 58 to store them (Step S284). The in-store terminal 14 sends the billing information and the point information to the digital photo frame 12 via the network 18 on particular occasions such as completion of content reproduction by the digital photo frame 12 (Step S286).

The digital photo frame 12 receives the billing information and the point information (Step S288) to display them on the display 22 of the reproduction means 20 (Step S290).

In the example, the contents are changed in accordance with the location of the digital photo frame 12. However, the present invention is not particularly limited to this. As another example, when it is found that the digital photo frame 12 is located in a kitchen, based on the analysis of an image taken by a camera or on sounds of cooking collected by a microphone as the sensing means 40, a recipe may be displayed as contents.

In yet another example, by detecting ambient sounds by a microphone as the sensing means 40, when it is determined that the user is watching a television or playing music, sound contents may be excluded from the contents to be reproduced.

In particular, contents may be generated or changed in accordance with other environmental information, than the location information of the digital photo frame 12, including information on persons, time/season, and position as shown in Table 6.

TABLE 6

| Environmental information | | | Examples of generated contents |
|---|---|---|---|
| Persons | Posture | Sitting | Contents with large movements |
| | | Standing | Contents with small movements |
| | | | With a little text |
| | Direction | To DPF | Include visuals to attract attention |
| | of Eyes | Not to DPF | Include background music to attract attention |
| | Distance | Short | Can include fine contents |
| | | | With large movements |
| | | Long | With small movements |
| | | | Large text characters |
| | Age | — | Contents suitable for viewers' ages |
| | — | Chatting | Subdued background music |
| Time/Season | — | — | Suitable for the season (Christmas, etc.) |
| | | | Suitable for the time of day (morning, day |
| | | | time, night, etc.) |
| Installation | Room | See Tables 4, 5 | — |
| of DPF | Position | Placed on floor | Supposing a plurality of persons are viewing |
| | | | and listening at a certain distance, |
| | | | Contents with small movements or with |
| | | | large-size display |
| | | | Contents enjoyable by many people |
| | | Hand-held | Supposing one person be viewing and listening |
| | | | closely, |
| | | | Contents with large movements or fine |
| | | | contents are acceptable |
| | | | Personal contents |

Among the examples of generated contents shown in Table 6, the contents with large movements include those in which a plurality of small images 102 move over the screen of the display 22 of the digital photo frame 12 as illustrated in FIG. 17. The contents with small movements include those in which images 104 are displayed on the display 22 of the digital photo frame 12, one at a time, one following the other successively as in a slideshow mode, as illustrated in FIG. 18.

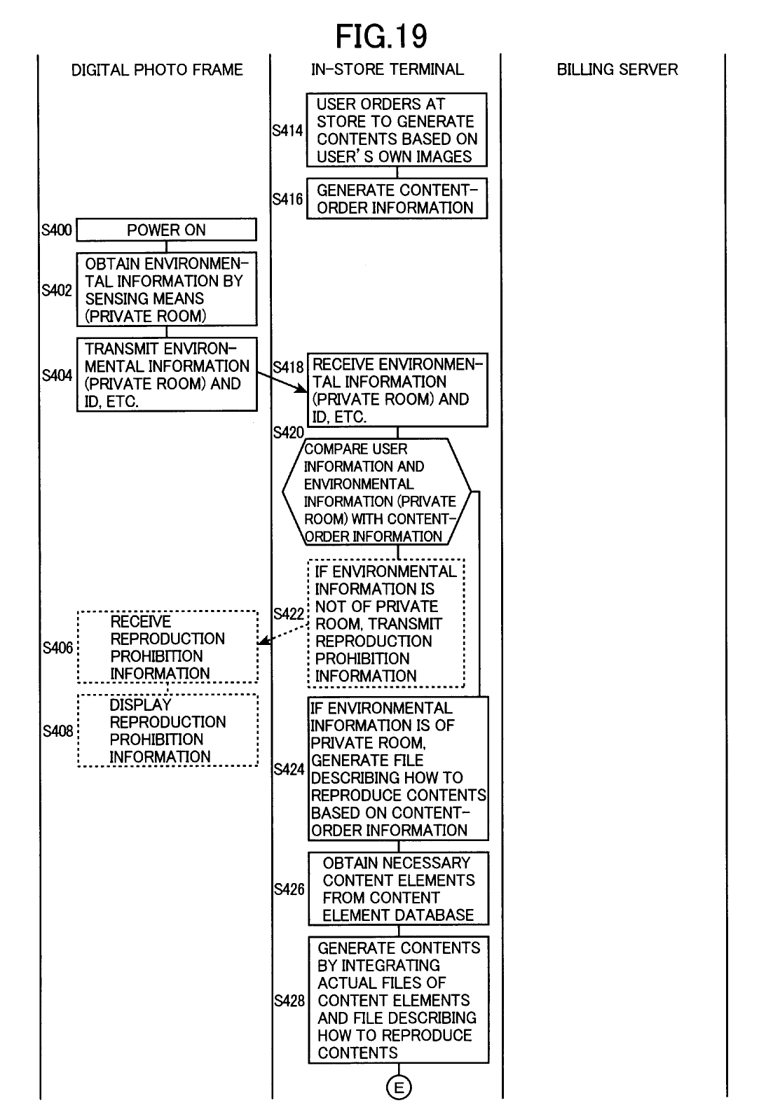

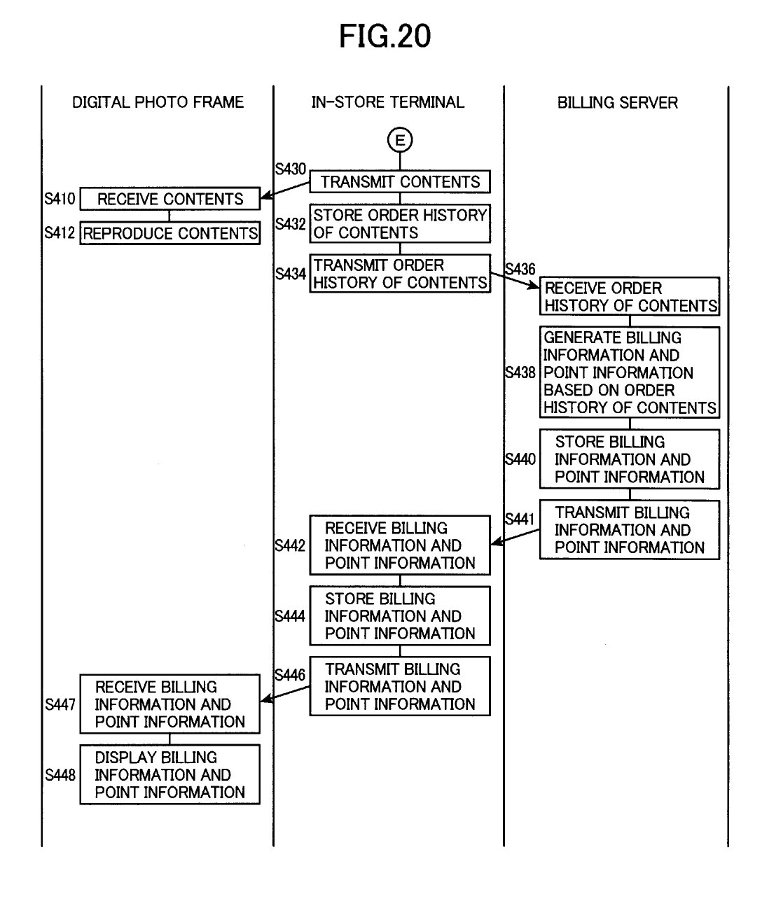

Next, FIG. 19 and FIG. 20 illustrate a flow of a case where the in-store terminal 14 automatically places a limitation on contents to be delivered in accordance with the environmental (location) information in the content delivery system 90 according to the second embodiment. Another example of the content delivery as Example 5 is described below with reference to FIG. 19 and FIG. 20.

### Example 5

First, the user places an order to a store at which the terminal 14 is installed to generate a set of contents based on images the user owns (Step S414). The order of the user and the user's images are input by the data input means 50 and are stored in the storage means 58 in the in-store terminal 14. Based on the input order, the user information management means 66 generates content-order information (Step S416).

The user returns home and turns on the digital photo frame 12 in his or her private room (Step S400).

The digital photo frame 12 is started and then obtains the environmental information indicating a private room by the sensing means 40 (Step S402). The environmental information thus obtained is transmitted to the in-store terminal 14 via the network 18 (Step S404). Together with the environmental information, the digital photo frame 12 may also send information to identify the user such as the ID of the digital photo frame 12, thereby allowing the in-store terminal 14 to determine whose digital photo frame 12 has sent the environmental information.

The in-store terminal 14 receives the environmental information together with, for example, the ID of the digital photo frame 12 transmitted by the digital photo frame 12 (Step S418), retrieves the user information stored in the storage means 58 based on the received ID of the digital photo frame 12 or the like and compares the user information and the environmental information to the content-order information (Step S420).

When the environmental information is of a private room like in this example, the content generation/modification means 54 of the in-store terminal 14 generates a file describing how to reproduce the contents based on the content-order information (Step S424).

The content generation/modification means 54 takes necessary content elements out of the content element database (Step S426) and generates a set of contents to transmit to the digital photo frame 12 based on actual files of the content elements stored in the storage means 58 and the file describing how to reproduce the contents (Step S428).

The in-store terminal 14 transmits the set of contents thus generated to the digital photo frame 12 via the network 18 (Step S430).

The digital photo frame 12 receives the contents in the reception means 38 of the communication section 34 (Step S410) and sends the contents to the control section 30. The control section 30 stores the contents in the storage means 32 when necessary or, in streaming delivery, does not store but transmits the contents to the reproduction means 20 to allow the contents to be instantly reproduced by the display 22 and the sound reproducer 24 (Step S412).

Here, the content received by the digital photo frame 12 may be removed from the storage means 32 or may be kept in the storage means 32 but prohibited from being reproduced if the digital photo frame 12 is carried out of the private room and brought to, for example, a living room where reproduction of the contents is not allowed. If the digital photo frame 12 is brought back to the private room, the contents will be obtained from the in-store terminal 14 again to be reproduced in the case where the contents were already removed from the storage means 32, or will be taken out from the storage means 32 to be reproduced in the case where the contents were stored in the storage means 32.

Upon completion of delivery of the set of contents to the digital photo frame 12, the in-store terminal 14 stores an order history of the contents in the storage means 58 (Step S432) and further transmits the order history to the billing server 16 via the network 18 (Step S434).

The billing server 16 receives the order history of the contents in the reception means 80 of the communication section 76 (Step S436) and forwards the order history to the control section 74. The control section 74 transmits the order history of the contents to the billing management means 70 and the point management means 72 to generate the billing information in the billing management means 70 and information on loyalty program points in the point management means 72 (Step S438). The billing information and the point information are stored in the storage means 82 (Step S440) and are additionally transmitted to the in-store terminal 14 via the network 18 (Step S441). The billing information and the point information may be a conversion result of the loyalty program points when the user uses his or her loyalty program points for the order and thus is not billed.

The in-store terminal 14 receives the billing information and the point information in the reception means 64 of the communication section 60 (Step S442) and forwards them to the control section 56. The control section 56 then sends the billing information and the point information to the storage means 58 to store them (Step S444). The in-store terminal 14 sends the billing information and the point information to the digital photo frame 12 via the network 18 on particular occasions such as completion of content reproduction by the digital photo frame 12 (Step S446).

The digital photo frame 12 receives the billing information and the point information (Step S447) to display them on the display 22 of the reproduction means 20 (Step S448).

If the environmental information is not of a private room, in Step S420, the in-store terminal 14 sends content-reproduction prohibition information to the digital photo frame 12 via the network 18 (Step S422).

The digital photo frame 12 receives the content-reproduction prohibition information in the reception means 38 of the communication section 34 (Step S406) and forwards the information to the control section 30. The control section 30 then sends the content-reproduction prohibition information to the reproduction means 20 to display the content-reproduction prohibition information on the display 22 (Step S412).

In this step, the user may be notified by the display that the present location prohibits content reproduction and of areas in which content reproduction is allowed.

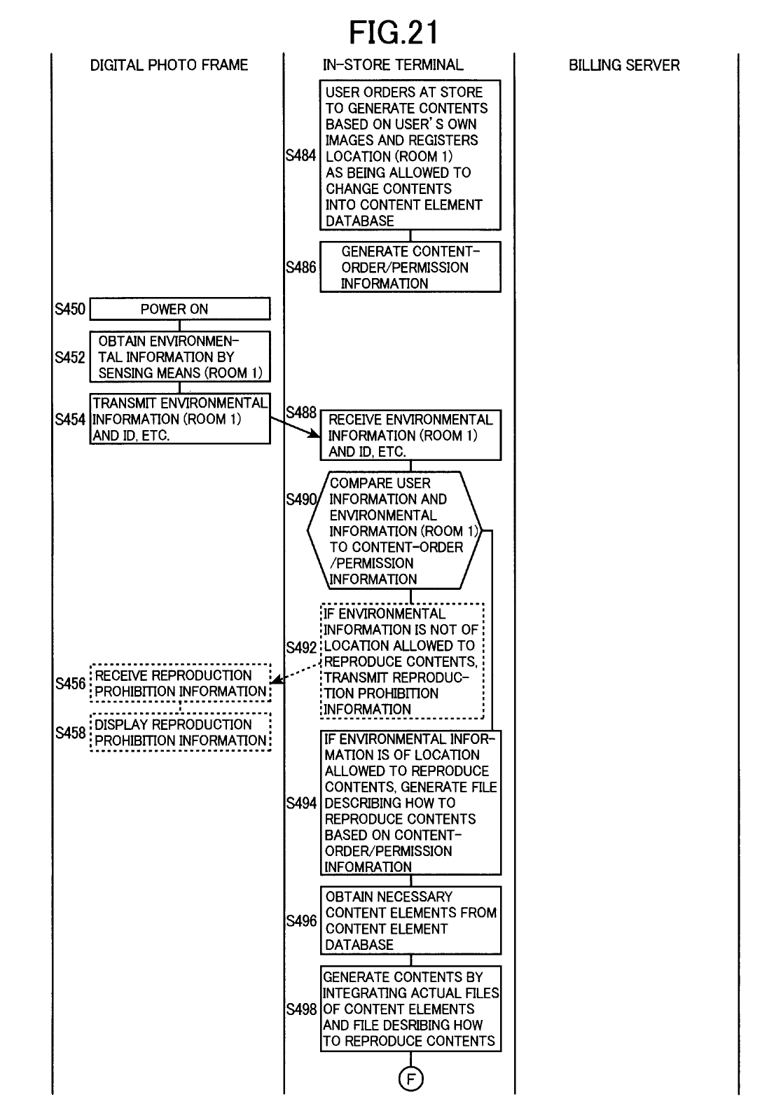

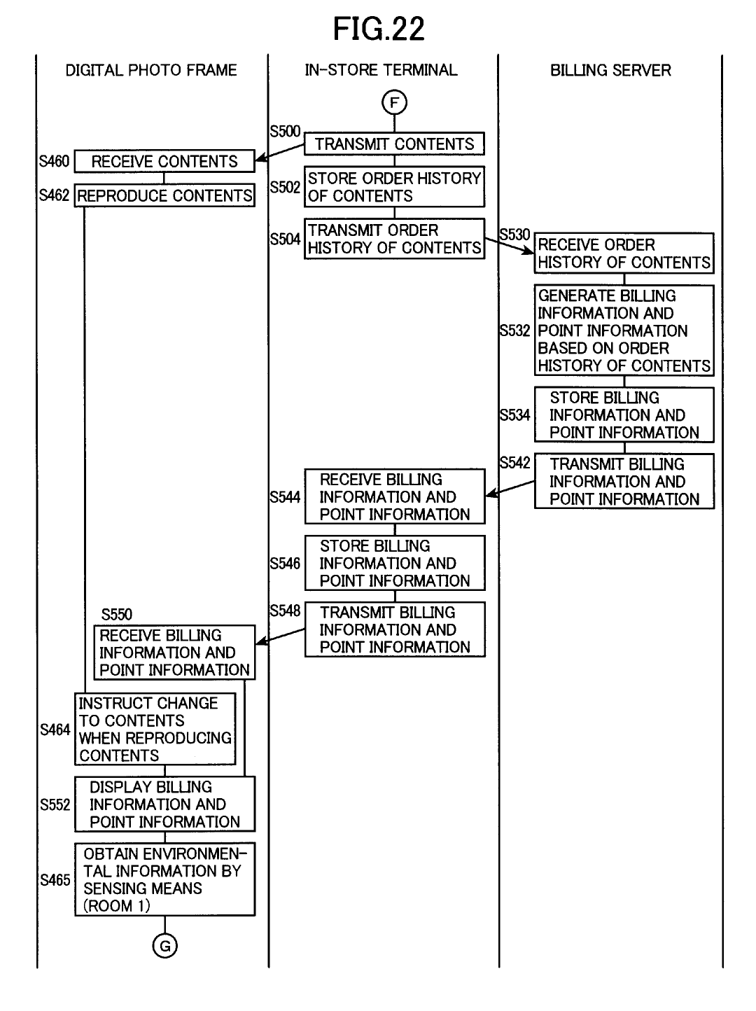

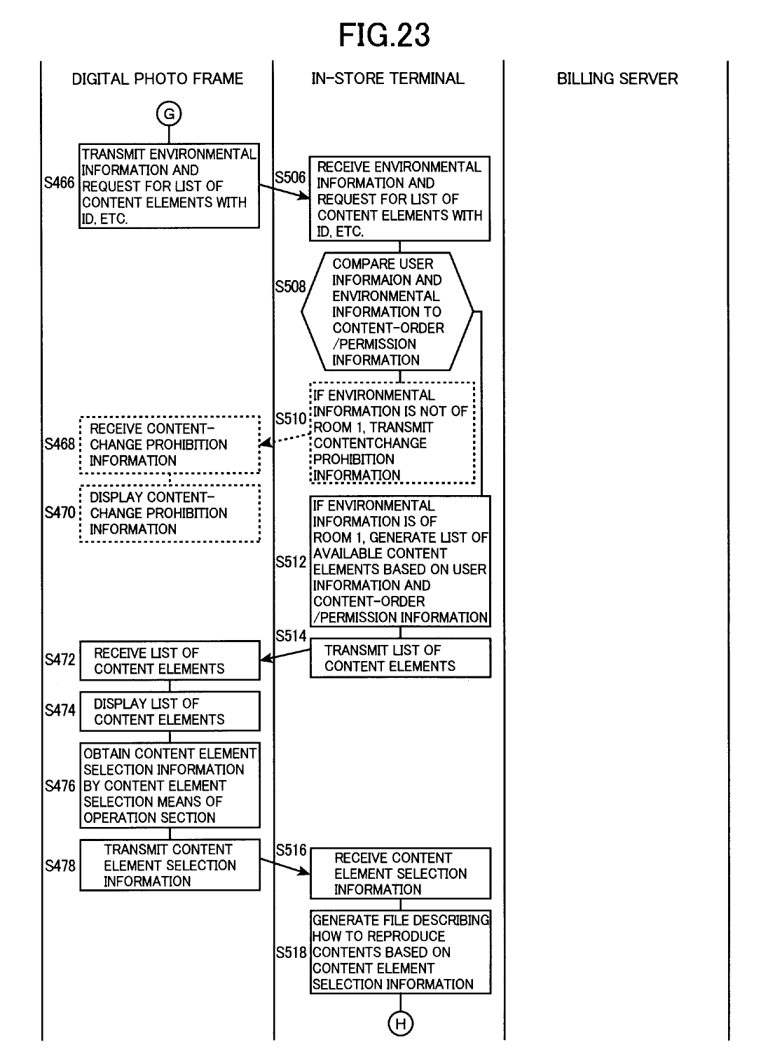

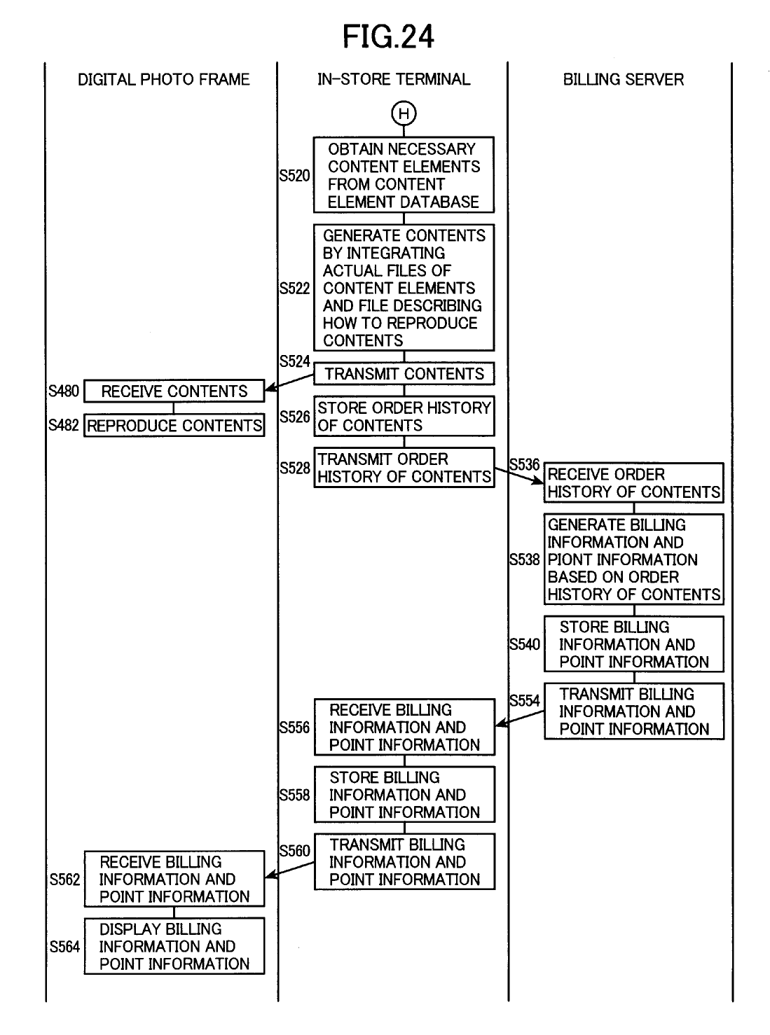

Next, FIG. 21 to FIG. 24 illustrate a flow of a case where content elements composing a set of contents to be delivered are changed under control in accordance with the environmental (location) information in the content delivery system 90 according to the second embodiment. Another example of the content delivery as Example 6 is described below with reference to FIG. 21 to FIG. 24.

### Example 6

First, the user places an order to a store at which the terminal 14 is installed to generate a set of contents based on images the user owns, and the user registers a particular location, e.g., Room 1, as a location in which it is allowed to change the contents (Step S484). In addition, a location where it is allowed to reproduce contents, or permission for a specific change to the set of contents such as addition or deletion of an image, permission for change to each content element, and the like can be set.

The order, permission information and images of the user are input through the data input means 50 of the in-store terminal 14 and are stored in the storage means 58. Based on the order and permission information thus input, content-order/permission information is generated by the user information management means 66 (Step S486). An example of content-order/permission information is shown in Table 7.

TABLE 7

| | | | Addition/deletion | Change of | Change of |
|---|---|---|---|---|---|
| | | Reproduction | of images | template | music |
| Living | Contents shared by | Allowed | Allowed | Allowed | Allowed |
| Room | whole family | | | | |
| | User A's contents | Allowed | Not allowed | Not allowed | Not allowed |
| Room 1 | Contents shared by | Allowed | Not allowed | Not allowed | Not allowed |
| | whole family | | | | |
| | User A's contents | Allowed | Allowed | Allowed | Allowed |
| Room 2 | . . . | | | | |

The user returns home and turns on the digital photo frame 12 in his or her private room (Step S450).

The digital photo frame 12 is started and then obtains the environmental information as Room 1 by the sensing means 40 (Step S452). The environmental information thus obtained is transmitted to the in-store terminal 14 via the network 18 (Step S454). Together with the environmental information, the digital photo frame 12 may also send information to identify the user such as the ID of the digital photo frame 12, thereby allowing the in-store terminal 14 to determine whose digital photo frame 12 has sent the environmental information.

The in-store terminal 14 receives the environmental information together with, for example, the ID of the digital photo frame 12 transmitted by the digital photo frame 12 (Step S488), retrieves the user information stored in the storage means 58 based on the received ID of the digital photo frame 12 or the like and compares the user information and the environmental information to the content-order/permission information (Step S490).

When the environmental information is of Room 1 like in this example, the content generation/modification means 54 of the in-store terminal 14 generates a file describing how to reproduce the contents based on the content-order/permission information (Step S494).

The content generation/modification means 54 takes necessary content elements out of the content element database (Step S496) and generates a set of contents to transmit to the digital photo frame 12 based on actual files of the content elements stored in the storage means 58 and the file describing how to reproduce the contents (Step S498).

The in-store terminal 14 transmits the set of contents thus generated to the digital photo frame 12 via the network 18 (Step S500).

The digital photo frame 12 receives the contents in the reception means 38 of the communication section 34 (Step S460) and sends the contents to the control section 30. The control section 30 stores the contents in the storage means 32 when necessary or, in streaming delivery, does not store but transmits the contents to the reproduction means 20 to allow the contents to be instantly reproduced by the display 22 and the sound reproducer 24 (Step S462).

Upon completion of delivery of the contents to the digital photo frame 12, the in-store terminal 14 stores an order history of the contents in the storage means 58 (Step S502) and further transmits the order history to the billing server 16 via the network 18 (Step S504).

The billing server 16 receives the order history of the contents in the reception means 80 of the communication section 76 (Step S530) and forwards the order history to the control section 74. The control section 74 transmits the order history of the contents to the billing management means 70 and the point management means 72 to generate the billing information in the billing management means 70 and information on loyalty program points in the point management means 72 (Step S532). The billing information and the point information are stored in the storage means 82 (Step S534) and are additionally transmitted to the in-store terminal 14 via the network 18 (Step S542). The billing information and the point information may be a conversion result of the loyalty program points when the user uses his or her loyalty program points for the order and thus is not billed.

The in-store terminal 14 receives the billing information and the point information in the reception means 64 of the communication section 60 (Step S544) and forwards them to the control section 56. The control section 56 then sends the billing information and the point information to the storage means 58 to store them (Step S546). The in-store terminal 14 sends the billing information and the point information to the digital photo frame 12 via the network 18 (Step S548).

The digital photo frame 12 receives the billing information and the point information (Step S550).

While the delivered contents are reproduced by the digital photo frame 12, the user instructs a change to the contents through the operation section 26 (Step S464). Once an instruction for a change to the contents or the like is made, the billing information and the point information received in Step S550 are displayed on the display 22 of the reproduction means 20 (Step S552). The digital photo frame 12 obtains the environmental information indicating Room 1 by the sensing means 40 (Step S465) and transmits the environmental information and a request for a list of content elements to the in-store terminal 14 via the network 18 (Step S466). Together with the request for a list of content elements, the digital photo frame 12 may also send information to identify the user such as the ID of the digital photo frame 12, thereby allowing the in-store terminal 14 to determine whose digital photo frame 12 has sent the request for a list of content elements.

The in-store terminal 14 receives the environmental information and the request for a list of content elements, together with, for example, the ID of the digital photo frame 12 transmitted by the digital photo frame 12 (Step S506), retrieves the user information stored in the storage means 58 based on the received ID of the digital photo frame 12 or the like and compares the user information and the environmental information to the content-order/permission information (Step S508).

When the environmental information indicating Room 1 as in this example, the content generation/modification means 54 of the in-store terminal 14 generates a list of available content elements based on the user information and the content-order/permission information (Step S512). Available content elements include those originally owned by the user and preliminarily input in the in-store terminal 14, thereby being registered in the content element database, and those originally owned by the store and registered in the content element database.

The in-store terminal 14 transmits the list of content elements thus generated to the digital photo frame 12 via the network 18 (Step S514).

The digital photo frame 12 receives the list of content elements (Step S472) and displays the list on the display 22 of the reproduction means 20 (Step S474). Here, the sound reproducer 24 may play a sound in order to let the user know that the list of content elements is displayed.

The user selects content elements the user wishes to reproduce out of the list of content elements on the display 22 by using the content element selection means 28 of the operation section 26.

The digital photo frame 12 obtains content element selection information on the content elements selected by the content element selection means 28 (Step S476) and sends the information to the in-store terminal 14 via the network 18 (Step S478).

The in-store terminal 14 receives the content element selection information in the reception means 64 of the communication section 60 (Step S516), and the content element selection information is sent to the content generation/modification means 54. The content generation/modification means 54 generates a file describing how to reproduce the contents based on the content element selection information (Step S518).

The content generation/modification means 54 takes necessary content elements out of the content element database (Step S520) and generates a set of contents to transmit to the digital photo frame 12 based on actual files of the content elements stored in the storage means 58 and the file describing how to reproduce the contents (Step S522).

The in-store terminal 14 transmits the set of contents thus generated to the digital photo frame 12 via the network 18 (Step S524). In this step, contents of a movie may be streamed by means of UDP/IP.

The digital photo frame 12 receives the contents in the reception means 38 of the communication section 34 (Step S480) and sends the contents to the control section 30. The control section 30 stores the contents in the storage means 32 when necessary or, in streaming delivery, does not store but transmits the contents to the reproduction means 20 to allow the contents to be instantly reproduced by the display 22 and the sound reproducer 24 (Step S482).

Upon completion of delivery of the contents to the digital photo frame 12, the in-store terminal 14 stores an order history of the contents in the storage means 58 (Step S526) and further transmits the order history to the billing server 16 via the network 18 (Step S528).

The billing server 16 receives the order history of the contents in the reception means 80 of the communication section 76 (Step S536) and forwards the order history to the control section 74. The control section 74 transmits the order history of the contents to the billing management means 70 and the point management means 72 to generate the billing information in the billing management means 70 and information on loyalty program points in the point management means 72 (Step S538). The billing information and the point information are stored in the storage means 82 (Step S540) and are additionally transmitted to the in-store terminal 14 via the network 18 (Step S554). The billing information and the point information may be a conversion result of the loyalty program points when the user uses his or her loyalty program points for the order and thus is not billed.

The in-store terminal 14 receives the billing information and the point information in the reception means 64 of the communication section 60 (Step S556) and forwards them to the control section 56. The control section 56 then sends the billing information and the point information to the storage means 58 to store them (Step S558). The in-store terminal 14 sends the billing information and the point information to the digital photo frame 12 via the network 18 on particular occasions such as completion of content reproduction by the digital photo frame 12 (Step S560).

The digital photo frame 12 receives the billing information and the point information (Step S562) to display them on the display 22 of the reproduction means 20 (Step S564).

If the environmental information is not of a location where content reproduction is allowed, in Step S490, the in-store terminal 14 sends content-reproduction prohibition information to the digital photo frame 12 via the network 18 (Step S492).

The digital photo frame 12 receives the content-reproduction prohibition information in the reception means 38 of the communication section 34 (Step S456) and forwards the information to the control section 30. The control section 30 then sends the content-reproduction prohibition information to the reproduction means 20 to display the content-reproduction prohibition information on the display 22 (Step S458).

In this step, the user may be notified by the display that the present location prohibits content reproduction and of areas in which content reproduction is allowed.

If the environmental information is not of a location where changes to the contents are allowed, in Step S508, the in-store terminal 14 sends content-change prohibition information to the digital photo frame 12 via the network 18 (Step S510).

The digital photo frame 12 receives the content-change prohibition information in the reception means 38 of the communication section 34 (Step S468) and forwards the information to the control section 30. The control section 30 then sends the content-change prohibition information to the reproduction means 20 to display the content-change prohibition information on the display 22 (Step S470).

In this step, the user may be notified by the display that the present location prohibits any change to the contents and of areas in which changes to the contents are allowed.

Note that in each of the examples described above, the digital photo frame 12 may be designed to be capable of reproducing contents by itself even if the digital photo frame 12 is carried out of an area where it can be connected with the network 18. More specifically, the storage means 32 of the digital photo frame 12 preliminarily stores content elements to form contents, and the control section 30 in place of the content generation/modification means 54 generates the contents, thereby enabling the digital photo frame 12 to reproduce contents in an area where no connection with the network 18 is available.

The content elements stored in the storage means 32 can include still images, music, and motion pictures the user saved in the storage means 32 in advance. In addition, the content elements or contents originally owned by the in-store terminal 14 and downloaded and saved into the storage means 32 during a past connection with the network 18 may also be used again. (Hereinafter, those content elements or contents saved in the storage means 32 are referred to as “local-contents”.)

Also, the digital photo frame 12 may be designed to reproduce not only contents delivered from the in-store terminal 14 (referred to as “server-contents”) but also local-contents at a time, even when it is located in an area where connection with the network 18 is available.

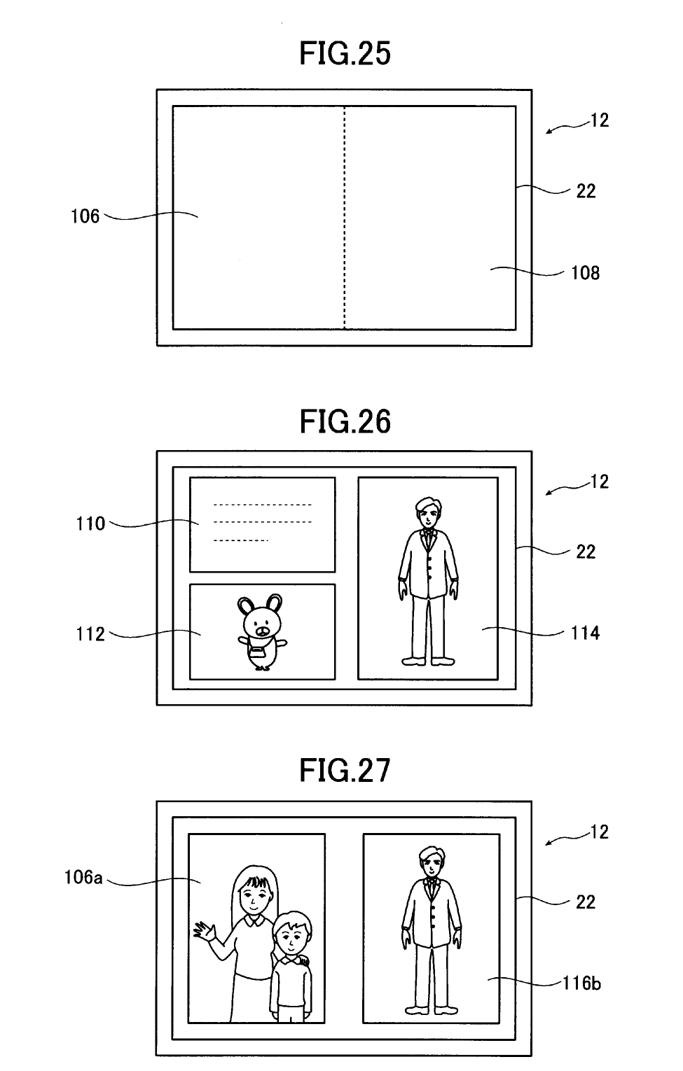

For instance, as shown in FIG. 25, the screen of the display 22 of the digital photo frame 12 is divided into a server-contents display area 106 and a local-contents display area 108, to display the respective contents in the respective areas.

If the digital photo frame 12 is connected with the network 18, as illustrated in FIG. 26, in the left area of the screen on the display 22, displayed are the server-contents including an advertisement 110 of a store or of some promotional campaign on the top and a character image 112 at the bottom, while in the right area of the screen on the display 12, displayed are the local-contents, that is, the user's image 114.

In the case where the digital photo frame 12 is not connected with the network 18, as shown in FIG. 27, both of the left and right areas of the screen display the local-contents, local images 116a and 116b.

With such a constitution described above, the user can enjoy the contents regardless of whether the digital photo frame 12 is connected with the network 18 or not.

As described above, according to the present invention, the content delivery system can automatically generate a set of contents based on content elements selected by a user and deliver them to the user.

And, another embodiment of the present invention can automatically determine content elements to use in accordance with user information and can automatically generate and deliver a set of contents.

Another embodiment of the present invention obtains environmental information about a data reproduction device and thus can automatically generate a set of contents suitable for the environment where the data reproduction device is located.

Furthermore, another embodiment of the present invention can promote sales of contents by automatically generating a set of contents in accordance with environmental information, an order history, promotional campaign information, order status, etc. and by recommending the contents to the user.

Another embodiment of the present invention can provide access limitation in accordance with a surrounding environment by specifying an environment (location) to allow reproduction of contents or specifying an environment (location) to allow making a change to contents.

Another embodiment of the present invention can prevent repeatedly recommending or delivering same contents as those in the user's delivery history by setting a degree of recommendation on contents.

Yet another embodiment of the present invention can bill the user or assign the user loyalty program points in accordance with the user's purchase status.

The content delivery system, the method for delivering contents, and a program of delivering contents according to the present invention have been described in detail. However, the present invention is by no means limited to the above-described embodiments; various improvements and modifications can be made without departing from the gist of the present invention.

What is claimed is:

1. A data reproduction device comprising:
reproduction means for displaying a list of content elements that is generated based on data obtained from content information on at least one of a still image, a motion picture, text and music and reproducing contents that are generated and modified based on content elements selected from the list of content elements;
content element selection means for selecting content elements from the list of content elements displayed by the reproduction means and generating content element selection information on the selected content elements;
first transmission means for transmitting the content element selection information generated by the content element selection means to an in-store terminal;
first reception means for receiving from the in-store terminal the list of content elements and the contents to be reproduced; and
first storage means for storing the list of content elements and the contents received by the first reception means.

2. The data reproduction device according to claim 1, further comprising sensing means for obtaining environmental information on surroundings of the data reproduction device.

3. A content delivery system in which the data reproduction device according to claim 1 and an in-store terminal are connected with each other via a communication line,
wherein the in-store terminal comprises:
data input means for inputting the content information on at least one of a still image, a motion picture, text and music as the data;
content element generation means for processing the data input by the data input means to generate the content elements and the list of the content elements;
second reception means for receiving the content element selection information from the data reproduction device;
content generation/modification means for generating and modifying the contents based on the content elements by using the content element selection information;
second storage means for storing the input data, the generated content elements, the generated and modified contents, and user information; and
second transmission means for transmitting the list of content elements and the generated and modified contents to the data reproduction device, and
wherein the in-store terminal generates the contents based on the content elements selected by the data reproduction device, and the data reproduction device reproduces the contents received from the in-store terminal.

4. The content delivery system according to claim 3, wherein the in-store terminal further comprises user information management means for managing the user information on a user to whom the generated and modified contents are delivered.

5. The content delivery system according to claim 4, wherein the content generation/modification means automatically selects on the content elements and generates the contents in accordance with the user information.

6. The content delivery system according to claim 5, wherein the data reproduction device comprising sensing means for obtaining environmental information on surroundings of the data reproduction device, and the content generation/modification means sends the data reproduction device either one or both of a menu of the content elements automatically selected and the contents in accordance with the environmental information and the user information and allows the contents to be changed by the user.

7. The content delivery system according to claim 5, wherein the data reproduction device comprising sensing means for obtaining environmental information on surroundings of the data reproduction device, and the content generation/modification means automatically selects the content elements in accordance with the environmental information and the user information and generates the contents.

8. The content delivery system according to claim 6, wherein the content generation/modification means sends the data reproduction device either one or both of a menu of the content elements automatically selected and the contents further in accordance with store-originated information prepared by the in-store terminal and allows the contents to be changed by the user.

9. The content delivery system according to claim 7, wherein the content generation/modification means automatically selects the content elements further in accordance with store-originated information prepared by the in-store terminal and generates the contents.

10. The content delivery system according to claim 6, wherein a content element selected by the content generation/modification means in accordance with at least one of the content element selection information, the environmental information, the user information and store-originated information is delivered as it is as the contents.

11. The content delivery system according to claim 6, wherein the content generation/modification means automatically controls delivery of the contents in accordance with content-order information and the environmental information, the content-order information including an order for the contents and permission for reproduction of the contents the user preliminarily inputs.

12. The content delivery system according to claim 6, wherein the content generation/modification means automatically controls delivery of the contents and changes to the contents in accordance with content-order/permission information and the environmental information, the content-order/permission information including an order for the contents and permission for reproduction of and changes to the contents the user preliminarily inputs.

13. The content delivery system according to claim 5, wherein the content generation/modification means refers to the user information and lowers a degree of recommendation of the contents and the content elements already included in an order history of the user.

14. The content delivery system according to claim 3, further comprising a billing server connected via a communication line, wherein the billing server comprises:
third reception means for receiving an order history from the in-store terminal;
billing management means for generating and managing billing information based on the order history;
point management means for generating and managing point information based on the order history; and
third storage means for storing the billing information and the point information.

15. A method for delivering contents for which a data reproduction device and an in-store terminal communicate with each other, comprising steps of:
inputting data of at least one of a still image, a movie, text and music into the in-store terminal;
processing the data to generate content elements and a list of content elements in the in-store terminal;
transmitting the list of content elements from the in-store terminal to the data reproduction device;
receiving the list of content elements transmitted from the in-store terminal by the data reproduction device;
displaying the list of content elements by reproduction means in the data reproduction device;
selecting content elements from the list of content elements by a user, the content elements being displayed by the reproduction means, and generating content element selection information by the data reproduction device;
transmitting the content element selection information from the data reproduction device to the in-store terminal;
receiving the content element selection information transmitted from the data reproduction device by the in-store terminal;
generating and modifying contents based on the content element selection information and the content elements by the in-store terminal;
transmitting the generated contents from the in-store terminal to the data reproduction device;
receiving the contents transmitted from the in-store terminal by the data reproduction device; and
reproducing the received contents by the data reproduction device.
